(19) United States
(12) Patent Application Publication
(10) Pub. No.: US 2019/0212689 A1
(43) Pub. Date: Jul. 11, 2019

(54) IMAGE FORMING APPARATUS

(71) Applicant: CANON KABUSHIKI KAISHA, Tokyo (JP)

(72) Inventor: Noriaki Matsui, Kashiwa-shi (JP)

(21) Appl. No.: 16/242,179

(22) Filed: Jan. 8, 2019

(30) Foreign Application Priority Data
Jan. 10, 2018 (JP) 2018-001820

(51) Int. Cl. G03G 15/00

(52) U.S. Cl. CPC G03G 15/6564; G03G 2215/00405; G03G 2215/00599; G03G 2215/00721

(57) ABSTRACT

An image forming apparatus which forms an image on a sheet based on a print job, comprising: a controller which controls a conveying portion and an image forming portion to stop the sheet at a predetermined position of the conveying path upstream of a transfer portion, and convey the sheet to the transfer portion after causing the image forming portion to start to form a image on the sheet in a case where the sheet reaches a detection portion but it is determined that the sheet which has been detected by the detection portion does not reach the transfer portion by transfer timing of the transfer portion based on timing when the detection portion detects the sheet.

### BACKGROUND OF THE INVENTION

### Field of the Invention

The present invention relates to an image forming apparatus such as a copying machine and a printer.

### Description of the Related Art

In an image forming apparatus such as a copying machine and a printer, a separation failure may occur in a feeding portion under the condition that various sheets are set. In this case, a retry is performed in the feeding portion as in US Patent Application Publication No. 2008/0025737 A1 to be able to reduce sheet jams and stabilize productivity (suppress a decrease in productivity).

However, in U.S. Patent Application Publication No. 2008/0025737 A1, there is room for improvement in preventing a non-reusable sheet (hereinafter, referred to as “invalid sheet”) from occurring and suppressing productivity from decreasing.

The present invention has been made to solve the above problems, and it is desirable to provide an image forming apparatus capable of securing stable productivity.

### SUMMARY OF THE INVENTION

In order to solve the above issue, a representative configuration of an image forming apparatus which forms an image on a sheet based on a print job, comprising: a sheet storing portion which stores a sheet; a detection portion which detects a sheet fed from the sheet storing portion; a conveying portion which conveys the sheet along a conveying path; an image forming portion which forms an image; a transfer portion which transfers the image formed by the image forming portion to the sheet; and a controller which controls the conveying portion and the image forming portion to stop the sheet at a predetermined position of the conveying path upstream of the transfer portion, and convey the sheet to the transfer portion after causing the image forming portion to start to form the image on the sheet in a case where the sheet reaches the detection portion but it is determined that the sheet which has been detected by the detection portion does not reach the transfer portion by transfer timing of the transfer portion based on timing when the detection portion detects the sheet.

Further features of the present invention will become apparent from the following description of exemplary embodiments with reference to the attached drawings.

### BRIEF DESCRIPTION OF THE DRAWINGS

FIG. 1 is a cross-sectional explanatory view showing a configuration of an image forming apparatus according to the present invention.

FIG. 2 is a block diagram showing a configuration of a controller.

FIG. 3A is a diagram showing an appearance in which a remaining jam of a sheet at a position of a sheet sensor provided upstream near a fixing device is detected.

FIG. 3B is a diagram showing an appearance in which a delayed jam of the sheet at the position of the sheet sensor provided upstream near the fixing device is detected.

FIG. 4 is a cross-sectional explanatory view for describing a sheet conveying operation after jam detection.

FIG. 5 is a cross-sectional explanatory view for describing the sheet conveying operation after the jam detection.

FIG. 6A is a diagram showing generation timing of an image forming start signal in a normal state. FIG. 6B is a transition diagram showing a transition from a leading end to a rear end of the sheet.

FIG. 7A is a diagram showing regeneration timing of the image forming start signal in a case in which it does not meet registration operation start timing. FIG. 7B is a transition diagram showing the transition from the leading end to the rear end of the sheet.

FIG. 8A is a diagram showing generation timing of an image forming start signal upon duplex printing. FIG. 8B is a transition diagram showing the transition from the leading end to the rear end of the sheet.

FIGS. 9A to 9D are diagrams showing an example of performing page management on each sheet using a page unit data as a page ID.

FIG. 10A is a diagram showing generation timing of an image forming start signal upon printing only a black color. FIG. 10B is a transition diagram showing the transition from the leading end to the rear end of the sheet.

FIG. 11 is a cross-sectional explanatory view for describing the sheet conveying operation in the case in which it does not meet the registration operation start timing.

FIG. 12 is a cross-sectional explanatory view for describing the sheet conveying operation in the case in which it does not meet the registration operation start timing.

FIG. 13 is a cross-sectional explanatory view for describing the sheet conveying operation in the case in which it does not meet the registration operation start timing.

FIG. 14 is a cross-sectional explanatory view for describing the sheet conveying operation in the case in which it does not meet the registration operation start timing.

FIG. 15 is a flowchart showing a determination as to whether there is a page.

FIG. 16 is a flowchart showing page processing.

FIG. 17 is a flowchart showing image forming processing.

FIG. 18 is a flowchart showing sheet feeding processing.

FIG. 19 is a flowchart showing sheet feeding retry processing.

FIG. 20 is a flowchart showing image forming retry processing.

### DESCRIPTION OF THE EMBODIMENTS

One embodiment of an image forming apparatus according to the present invention will be described in detail with reference to the accompanying drawings.

### <Image Forming Apparatus>

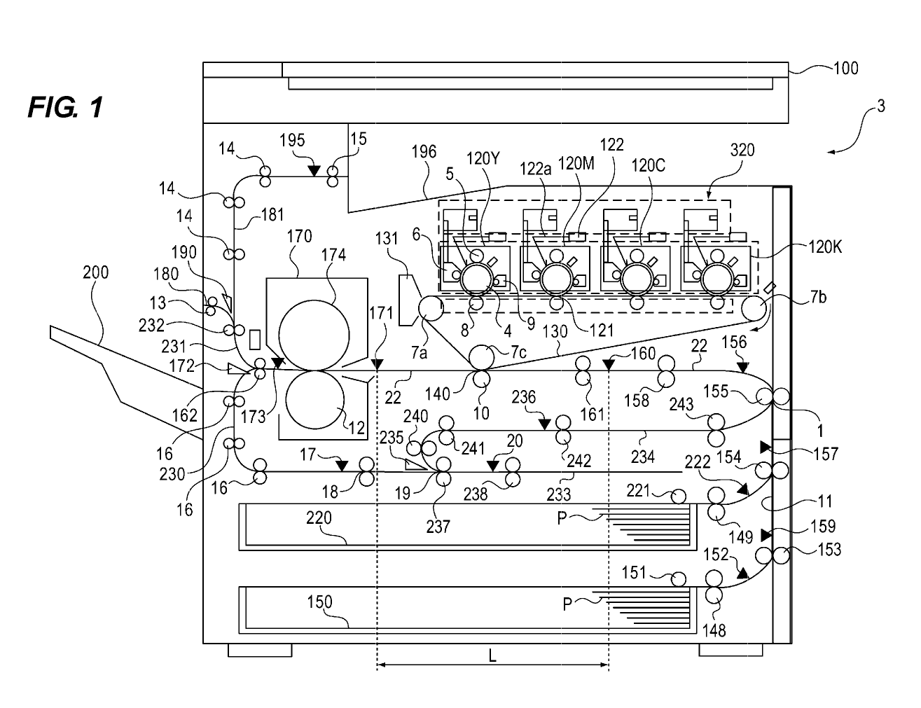

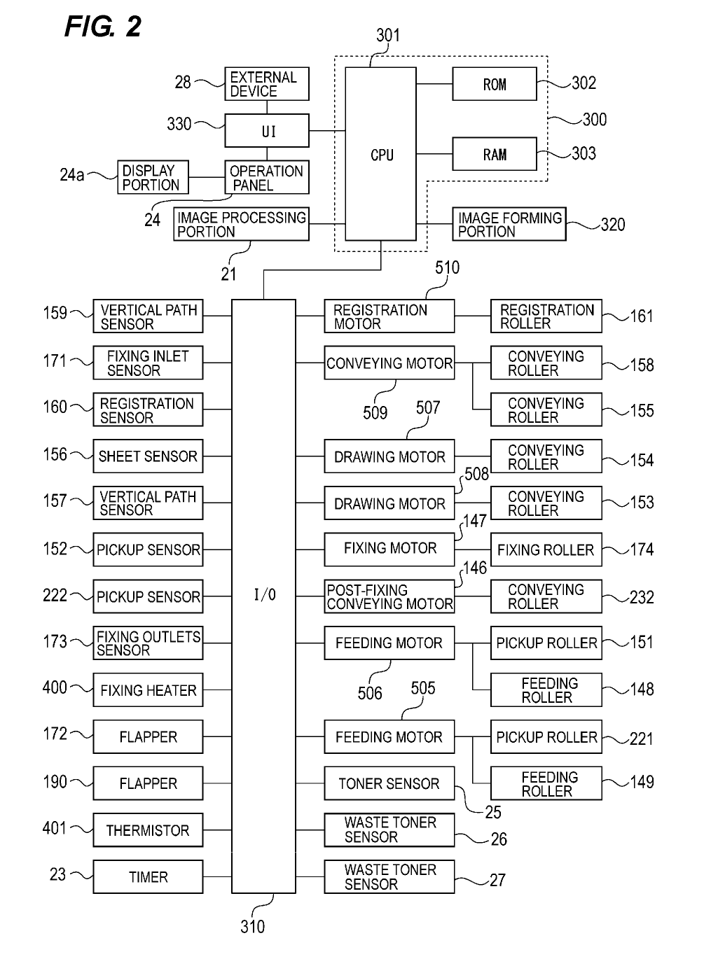

First, a configuration of an image forming apparatus 3 according to the present invention will be described with reference to FIGS. 1 and 2. FIG. 1 is a cross-sectional explanation diagram showing the configuration of the image forming apparatus 3 according to the present invention. FIG. 2 is a block diagram showing a configuration of a controller 300.

In the image forming apparatus 3 shown in FIG. 1, a discharge tray 196 is provided under an image reading portion 100 which reads an original image. An image forming portion 320 is provided under the discharge tray 196.

### <Image Forming Portion>

As shown in FIG. 1, the image forming portion 320 has each process unit 120Y, 120M, 120C, and 120K which forms images of each color of yellow Y, magenta M, cyan C, and black K. Since each process unit 120Y, 120M, 120C, and 120K is configured in substantially the same manner except that colors of developers (toners) accommodated in the process units 120Y, 120M, 120C, and 120K are different, a process unit 120 may be simply described. The same goes for other image forming process portions.

Each of the process units 120 is provided with photosensitive drums 4 as image bearing members corresponding to the respective colors of yellow Y, magenta M, cyan C, and black K. Each photosensitive drum 4 is rotated counterclockwise in FIG. 1.

A charging roller 5, a laser scanner unit 122, a developing device 6, a cleaner 9, and the like are provided around each photosensitive drum 4.

Surfaces of each photosensitive drum 4 are uniformly charged by each charging roller 5 as a charging portion. A laser beam 122a corresponding to image information of each color is emitted from the laser scanner unit 122 to the surfaces of the respective photosensitive drums 4 uniformly charged. As a result, electrostatic latent images corresponding to the image information of each color are formed on the surfaces of the respective photosensitive drums 4. Toners of each color serving as developers are supplied from developing devices 6 of each color, which serve as developing portions, to the electrostatic latent images formed on the surfaces of the respective photosensitive drums 4. As a result, toner images of each color are developed on the surfaces of the respective photosensitive drums 4.

### <Transfer Portion>

An intermediate transfer belt 130 rotatably stretched by stretching rollers 7a to 7c is provided so as to face each photosensitive drum 4. A primary transfer roller 8 as a primary transfer portion provided so as to face each photosensitive drum 4 with the intermediate transfer belt 130 nipped therebetween is provided on an inner peripheral surface side of the intermediate transfer belt 130.

By applying a primary transfer voltage from a primary transfer power supply (not shown) to each primary transfer roller 8, the toner images of each color formed on the surfaces of the respective photosensitive drums 4 are sequentially transferred onto an outer peripheral surface of the intermediate transfer belt 130. The residual toners remaining on the surfaces of the respective photosensitive drums 4 are recovered by each cleaner 9 as a cleaning portion. A secondary transfer roller 10 as a secondary transfer portion provided so as to face the stretching roller 7c with the intermediate transfer belt 130 nipped therebetween is provided on the outer peripheral surface side of the intermediate transfer belt 130. A secondary transfer portion 140 (transfer portion) is formed by a nip portion between the outer peripheral surface of the intermediate transfer belt 130 and the secondary transfer roller 10.

Here, in the image forming apparatus 3 having the secondary transfer portion 140 (transfer portion) using the intermediate transfer belt 130, an image forming operation is performed prior to starting to feed a sheet P. For the image forming operation, a variation of the feeding of the sheet P is corrected at transfer timing in the secondary transfer portion 140 performing an image transfer to the sheet P so that the sheet P meets the secondary transfer portion 140 (transfer portion). As a result, it is possible to stabilize productivity.

### <Fixing Portion>

A fixing device 170 as a fixing portion is provided downstream in a sheet conveying direction of the secondary transfer portion 140 (transfer portion). In the secondary transfer portion 140, the toner image formed on the outer peripheral surface of the intermediate transfer belt 130 is transferred to the sheet P. The sheet P onto which the toner image is transferred is nipped and conveyed by the outer peripheral surface of the intermediate transfer belt 130 and the secondary transfer roller 10, and is detected by a fixing inlet sensor 171. Then, the sheet P is conveyed to the fixing device 170.

The fixing device 170 is provided with a fixing roller 174 having a fixing heater 400 provided therein and a pressure roller 12. A CPU 301 turns on the fixing heater 400 provided in the fixing roller 174 via an I/O 310, and detects a temperature of the fixing heater 400 using a thermistor 401, thereby performing a temperature control of the fixing heater 400. While the sheet P on which the toner image is supported conveyed to the fixing device 170 is nipped and conveyed by the fixing roller 174 and the pressure roller 12, the toner image is heat-fixed to the sheet P.

### <Controller>

The image forming apparatus 3 shown in FIG. 1 includes a controller 300 shown in FIG. 2. The controller 300 includes a central processing unit (CPU) 301. In addition, the controller 300 includes a read only memory (ROM) 302. In addition, the controller 300 is configured to have a random access memory (RAM) 303. The CPU 301 controls an image forming portion 320.

### <Motor Control>

For example, an instruction to start printing is input to the CPU 301 from an operation panel 24 or an external device 28, such as a personal computer, shown in FIG. 2 via a user interface (UI) 330. Then, the CPU 301 controls driving of a fixing motor 147 connected via an input/output (I/O) 310. In addition, the CPU 301 controls driving of a post-fixing conveying motor 146. In addition, the CPU 301 controls driving of a conveying motor 510 which drives a registration roller 161.

In addition, the CPU 301 controls driving of a conveying motor 509 which drives a conveying rollers 155 and 158. In addition, the CPU 301 controls driving of a drawing motor 508 which draws out a sheet cassette 150. In addition, the CPU 301 controls driving of a drawing motor 507 which draws out a sheet cassette 220. In addition, the CPU 301 controls driving of a feeding motor 506 which conveys the sheet P accommodated in the sheet cassette 150. In addition, the CPU 301 controls driving of a feeding motor 505 which conveys the sheet P accommodated in the sheet cassette 220.

### <Sensor>

In addition, the CPU 301 detects an output signal of a fixing inlet sensor 171 connected via the I/O 310. In addition, the CPU 301 detects an output signal of a fixing outlet sensor 173. In addition, the CPU 301 detects an output signal of a registration sensor 160. In addition, the CPU 301 detects an output signal of a pickup sensor 152 which detects that the sheet P in the sheet cassette 150 is fed. In addition, the CPU 301 detects an output signal of a pickup sensor 222 which detects that the sheet P in the sheet cassette 220 is fed.

### <Sheet Feeding Portion>

The sheets P, which are recording materials accommodated in the respective sheet cassettes 150 and 220, are each fed out by pickup rollers 151 and 221, and separated and fed one by one by a separating portion (not shown). Then, the sheets P are each fed by feeding rollers 148 and 149, respectively, detected by the pickup sensors 152 and 222, and then guided to a vertical path 11. Then, the sheets P are each conveyed by conveying rollers 153 and 154 provided on the vertical path 11, and detected by vertical path sensors 159 and 157, respectively.

Then, the sheet P is conveyed by the conveying roller 155 and detected by the sheet sensor 156. Then, the sheet P is nipped and conveyed by the conveying roller 158 and detected by the registration sensor 160. Then, a leading end portion Pa of the sheet P abuts on a nip portion of the registration roller 161 which is not driven. As a result, skew feeding of the sheet P is corrected. Then, the registration roller 161 is rotated at a predetermined timing synchronized with the rotation driving of the intermediate transfer belt 130, and the sheet P is conveyed to the secondary transfer portion 140 formed by the outer peripheral surface of the intermediate transfer belt 130 and the secondary transfer roller 10.

A secondary transfer voltage is applied from a secondary transfer power supply (not shown) to the secondary transfer roller 10, and the toner image formed on the outer peripheral surface of the intermediate transfer belt 130 is transferred onto the surface of the sheet P. The residual toner remaining on the outer peripheral surface of the intermediate transfer belt 130 are recovered by a cleaner 131 as the cleaning portion. The CPU 301 performs a control of a high voltage applied to the charging roller 5, the primary transfer roller 8, the secondary transfer roller 10, and the like provided in the image forming portion 320 from various bias power supplies, a drive control of various motors, and furthermore, a control of the laser scanner unit 122.

### <Sheet Discharge Portion>

The sheet P on which the toner image is fixed by the fixing device 170 is detected by the fixing outlet sensor 173 and then is conveyed by the conveying roller 162, so that a conveying destination of the sheet P is switched to either a discharge path 231 or a duplex conveying path 230 by a rotation direction of a flapper 172. When the flapper 172 is in a posture shown in FIG. 1, the sheet P conveyed by the conveying roller 162 is guided to the discharge path 231 and conveyed by the conveying roller 232, and the conveying destination of the sheet P is switched to either the discharge path 180 or the discharge path 181 depending on a rotation direction of a flapper 190.

When the flapper 190 is in the posture shown in FIG. 1, the sheet P conveyed by the conveying roller 232 is guided to the discharge path 181. Then, the sheet P is conveyed by each conveying roller 14 and then detected by a discharge sensor 195. Then, the sheet P is discharged onto the discharge tray 196 provided above the image forming portion 320 by the discharge roller 15.

The flapper 190 shown in FIG. 1 is pivoted counterclockwise in FIG. 1 and the sheet P guided to the discharge path 180 is discharged onto the discharge tray 200 provided on a side surface of the image forming apparatus 3 by the discharge roller 13. The flapper 172 shown in FIG. 1 is pivoted counterclockwise in FIG. 1, and the sheet P guided to the duplex conveying path 230 is conveyed by the conveying rollers 16 and detected by the sheet sensor 17. Then, the sheet P is conveyed to a standby conveying path 233 by the conveying roller 18 and a reverse roller 237, and is detected by the sheet sensor 20. Then, the sheet P is conveyed by the reverse roller 238 and enters the standby conveying path 233. At this time, a first surface of the sheet P on which the toner image is fixed faces downward in the standby conveying path 233.

If a rear end portion in a traveling direction of the sheet P passes through a branching point 19, the flapper 235 shown in FIG. 1 is pivoted clockwise in FIG. 1. The reverse rollers 237 and 238 provided on the standby conveying path 233 rotate in a reverse direction and the sheet P entering the standby conveying path 233 is guided to the duplex feeding path 234 by inverting the traveling direction. Here, the duplex feeding path 234 is configured as a duplex feeding path for printing on a second surface of the sheet P. The duplex feeding path 234 is one of a plurality of feeding paths merged at a merging portion 1 shown in FIG. 1.

Then, the sheet P is conveyed to a duplex re-feeding rollers 240 and 241 provided on the duplex feeding path 234, detected by the duplex feeding sensor 236, and then conveyed by the duplex re-feeding rollers 242 and 243, so that the front and back surfaces of the sheet P are reversed. At this time, the first surface of the sheet P faces upward in the duplex feeding path 234.

Then, the sheet P is merged at the merging portion 1 on the vertical path 11 which is one of a plurality of feeding paths feeding the sheet P, and then is conveyed by the conveying roller 155 provided on the vertical path 11, and is detected by the sheet sensor 156. Then, the sheet P is nipped and conveyed by the conveying roller 158 and detected by the registration sensor 160. Then, a leading end portion in the traveling direction of the sheet P abuts on the nip portion of the stopped registration roller 161. As a result, the skew feeding of the sheet P is corrected. At this time, the first surface of the sheet P faces downward and the second surface of the sheet P faces upward.

Then, the registration roller 161 is rotated at a predetermined timing synchronized with the rotation driving of the intermediate transfer belt 130, and the sheet P is conveyed to the secondary transfer portion 140 formed by the outer peripheral surface of the intermediate transfer belt 130 and the secondary transfer roller 10. Similarly to the first surface, the toner image formed on the outer peripheral surface of the intermediate transfer belt 130 is transferred onto the second surface of the sheet P. Then, after the toner image is fixed on the sheet P by the fixing device 170, the sheet P is guided to the discharge path 231 by the flapper 172 and discharged onto the discharge tray 200 or the discharge tray 196.

The secondary transfer portion 140 (transfer portion) is provided on a downstream side in the sheet conveying direction with respect to the merging portion 1 where the vertical path 11 and the duplex feeding path 234 (plurality of feeding paths) shown in FIG. 1 merge. The secondary transfer portion 140 (transfer portion) transfers the image formed by the image forming portion 320 to the sheet P.

In the image processing portion 21 connected to the CPU 301, image data for copying and image data for printer output are stored in a compressed state. When the image forming operation is performed by the image forming apparatus 3, the image data is developed on a page basis. A compression ratio of the image data differs depending on the image data of each page. Therefore, the development time of the image data varies depending on each image data.

In general, a first in first out (FiFo) method by which image data first input are output first is executed. For this reason, in the case of image data of a plurality of pages whose input order is determined in advance, the development of the image data is performed at high speed, but when the image data of any page is developed again, an operation of searching pages is accompanied, so that the time to end the development is prolonged.

### <Image Forming Operation>

Next, an image forming operation by the image forming apparatus 3 will be described with reference to FIGS. 1 and 2. An instruction to start printing is input to the CPU 301 from the external device 28 such as a personal computer or the like provided outside the image forming apparatus 3 shown in FIG. 2 and from the operation panel 24 provided in the image forming apparatus 3 via a UI 330. In the case of feeding the sheet P from the lower sheet cassette 150 of the image forming apparatus 3 shown in FIG. 1, the CPU 301 rotates the feeding motor 506 as a driving source for the pickup roller 151 and the feeding roller 148 via the I/O 310. As a result, the pickup roller 151 and the feeding roller 148 are rotated.

The sheets P serving as recording materials in the lower sheet cassette 150 are fed one by one. At this time, the CPU 301 determines based on the detection result of the pickup sensor 152 whether the feeding operation of the sheet P in the sheet cassette 150 is performed normally. After the CPU 301 determines based on the detection result of the pickup sensor 152 that the feeding operation of the sheet P in the sheet cassette 150 is performed normally, the CPU 301 controls to rotate the drawing motors 508 and 507 and the conveying motor 509.

As a result, the sheet P is conveyed to the conveying path 22 via the vertical path 11 by the rotation of the conveying rollers 153 to 155 and 158. At this time, the position of the sheet P is monitored by the CPU 301 based on the detection results of the vertical path sensors 159 and 157, the sheet sensor 156, and the registration sensor 160.

Similarly, in the case of feeding the sheet P from the upper sheet cassette 220, the CPU 301 drives the feeding motor 505 as a driving source for the pickup roller 221 and the feeding roller 149 via the I/O 310. As a result, the pickup roller 221 and the feeding roller 149 are rotated.

The sheets P in the upper sheet cassette 220 are fed one by one. At this time, the CPU 301 determines based on the detection result of the pickup sensor 222 whether the feeding operation of the sheet P in the sheet cassette 220 is performed normally. After the CPU 301 determines based on the detection result of the pickup sensor 222 that the feeding operation of the sheet P in the sheet cassette 220 is performed normally, the CPU 301 controls to rotate the drawing motor 507 and the conveying motor 509. As a result, the sheet P is conveyed to the conveying path 22 via the vertical path 11 by the rotation of the conveying rollers 154, 155, and 158. At this time, the position of the sheet P is monitored based on the detection results of the vertical path sensor 157, the sheet sensor 156, and the registration sensor 160.

The CPU 301 determines the timing at which the leading end portion Pa in the conveying direction of the sheet P fed from each of the sheet cassettes 150 and 220 reaches the registration sensor 160. The CPU 301 controls the conveyance of the sheet P so that the leading end portion Pa of the sheet P and the leading end portion of the toner image formed on the outer peripheral surface of the intermediate transfer belt 130 coincide with each other at the secondary transfer portion 140 including the nip portion between the outer peripheral surface of the intermediate transfer belt 130 and the secondary transfer roller 10.

For example, when the leading end portion Pa of the sheet P arrives earlier than the specified timing with respect to the leading end portion of the toner image formed on the outer peripheral surface of the intermediate transfer belt 130, the CPU 301 controls the conveying motor 509 so that the leading end portion Pa of the sheet P abuts the nip portion of the registration roller 161 which is not rotated to set the time to stop the conveyance of the sheet P to be longer than the specified time. After stopping the registration roller 161 by a predetermined time+a, the CPU 301 causes the registration motor 510 to rotate the registration roller 161 to restart the conveyance of the sheet P again.

Here, if the leading end portion Pa of the sheet P abuts on the nip portion of the stopped registration roller 161 to stop the conveyance of the sheet P for a long time, there is a possibility that a trace of the conveying roller 158 may remain on the sheet P due to the influence of a nip pressure of the conveying roller 158 which nips and conveys the sheet P. The sheet P on which the trace of the conveying roller 158 remains is automatically discharged as a defective product. Here, the automatic discharge of the sheet P is a function of conveying the sheet P to the conveying path 22 at a steady speed without forming the image on the sheet P and discharging the sheet P onto each of the discharge trays 200 and 196.

The CPU 301 controls to start the image forming operation by the process unit 120 so as to meet the timing at which the sheet P reaches the secondary transfer portion 140. In the process unit 120, the surface of the photosensitive drum 4 is uniformly charged by the charging roller 5. Then, a laser beam 122a corresponding to the image information emitted from the laser scanner unit 122 is emitted to the surface of the photosensitive drum 4 uniformly charged. As a result, an electrostatic latent image is formed on the surface of the photosensitive drum 4.

The electrostatic latent image formed on the surface of the photosensitive drum 4 is supplied with the toner accommodated in the developing device 6 and developed as a toner image. Then, in the primary transfer portion 121 including the nip portion between the surface of the photosensitive drum 4 opposed to the primary transfer roller 8 and the outer peripheral surface of the intermediate transfer belt 130, a primary transfer voltage is applied from the primary transfer power supply (not shown) to the primary transfer roller 8. As a result, the toner image developed on the surface of the photosensitive drum 4 is transferred to the intermediate transfer belt 130.

The toner image transferred onto the outer peripheral surface of the intermediate transfer belt 130 moves to the secondary transfer portion 140 as the intermediate transfer belt 130 is rotated clockwise in FIG. 1. On the other hand, the sheet P nipped and conveyed by the registration roller 161 reaches the secondary transfer portion 140. At this time, a secondary transfer voltage is applied from the secondary transfer power supply (not shown) to the secondary transfer roller 10. As a result, in the secondary transfer portion 140, the toner image transferred to the intermediate transfer belt 130 is transferred onto the sheet P. The cleaner 131 is provided downstream in the rotation direction of the intermediate transfer belt 130 below the secondary transfer portion 140. The residual toner which is not transferred onto the sheet P in the secondary transfer portion 140 is recovered by the cleaner 131.

The sheet P to which the toner image is transferred is conveyed to a fixing device 170. The toner image on the sheet P is heat-fixed by the fixing device 170. Then, the leading end portion Pa of the sheet P on which the toner image is fixed is detected by the fixing outlet sensor 173. Then, the CPU 301 determines to which one of the duplex conveying path 230 and the discharge path 231 the sheet P is conveyed, based on an instruction designated in advance by the external device 28 or the operation panel 24. Then, the CPU 301 drives the flapper 172 to switch the posture.

As a result, the conveying destination of the sheet P nipped and conveyed by the conveying roller 162 is switched to either the duplex conveying path 230 or the discharge path 231. When an instruction on the duplex printing is given, the flapper 172 shown in FIG. 1 is rotated counterclockwise to convey the sheet P toward the duplex conveying path 230. The sheet P is guided to the standby conveying path 233 by each of the conveying rollers 16 and 18 and the reverse rollers 237 and 238 to be temporarily on standby.

Next, after rotating the flapper 235 shown in FIG. 1 in the clockwise direction, the reverse rollers 237 and 238 are rotated in the reverse direction, so that the sheet P being temporarily on standby in the standby conveying path 233 is guided to the duplex feeding path 234 by the flapper 235. When the sheet P is detected by the duplex feeding sensor 236 provided in the duplex feeding path 234, the CPU 301 determines that the sheet P to be duplex printed is fed normally. The sheet P is conveyed to the registration rollers 161 by the duplex re-feeding rollers 240 to 243 provided in the duplex feeding path 234, the conveying roller 155 provided in the vertical path 11, and the conveying roller 158 provided in the conveying path 22.

### <Discharge of Sheet>

In the case of printing only on one surface (first surface) of the sheet P or in the case of printing on the back surface (second surface) by the duplex printing of the sheet P, the sheet P having passed through the fixing device 170 is conveyed to the discharge path 231 by setting the flapper 172 in the posture shown in FIG. 1. The sheet P guided to the discharge path 231 by the flapper 172 set in the posture shown in FIG. 1 is further conveyed downstream by the conveying roller 232. At this time, the CPU 301 controls to pivot the flapper 190 to switch the posture based on an instruction designated in advance by the external device 28 or the operation panel 24.

Depending on the posture of the flapper 190, it is switched whether the sheet P is conveyed toward the discharge path 180 or conveyed toward the discharge path 181. When the discharge destination of the sheet P designated by the user is the discharge tray 200, the flapper 190 is rotated counterclockwise in FIG. 1. As a result, the sheet P nipped and conveyed by the conveying roller 232 is guided to the discharge path 180 by the flapper 190. The sheet P is discharged onto the discharge tray 200 by the discharge roller 13.

On the other hand, when the discharge destination of the sheet P designated by the user is the discharge tray 196, the flapper 190 is set in the posture shown in FIG. 1. As a result, the sheet P nipped and conveyed by the conveying roller 232 is guided to the discharge path 181 by the flapper 190. The sheet P is conveyed by the conveying rollers 14 and then discharged onto the discharge tray 196 by the discharge roller 15.

### <Jam Detection>

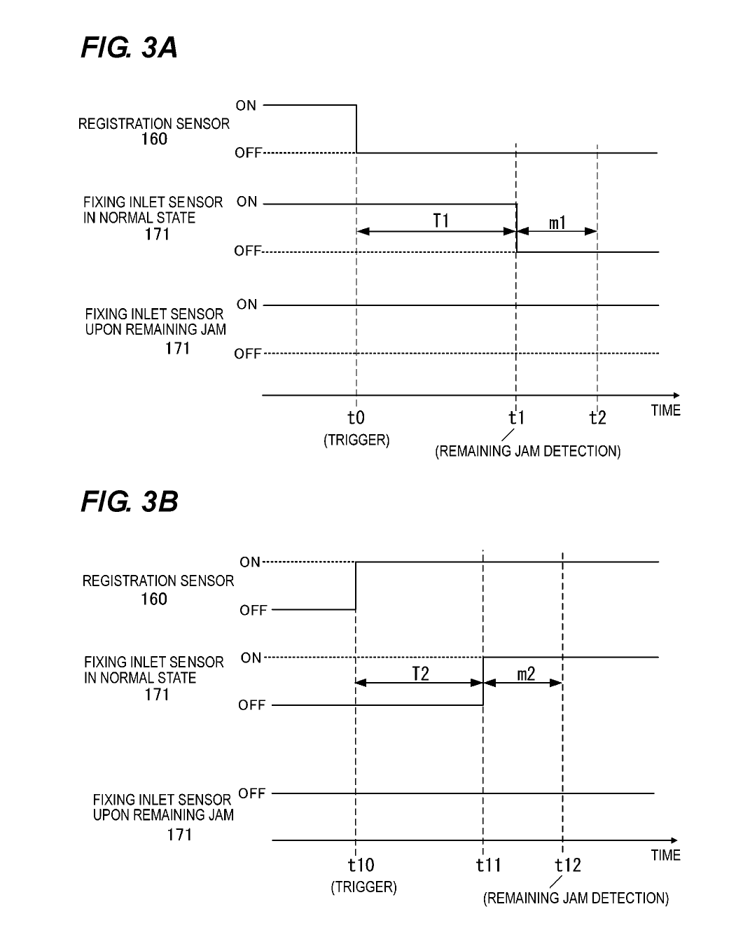

Next, the jam detection of the sheet P will be described with reference to FIGS. 3A and 3B. FIG. 3A is a diagram showing an appearance in which the remaining jam of the sheet P at the position of the fixing inlet sensor 171 is detected. FIG. 3B is a diagram showing an appearance in which the delayed jam of the sheet P at the position of the fixing inlet sensor 171 is detected.

FIGS. 3A and 3B show timing charts showing a change in the detection signal of the registration sensor 160 provided upstream near the registration roller 161 shown in FIG. 1 and the detection signal of the fixing inlet sensor 171 provided upstream near the fixing device 170 downstream of the secondary transfer portion 140.

### <Detection of Remaining Jam>

First, the detection of the remaining jam of the sheet P at the position of the fixing inlet sensor 171 shown in FIG. 1 will be described with reference to FIG. 3A. As shown in FIG. 3A, the sheet P is detected by the registration sensor 160 provided upstream near the registration roller 161. Time t0 at which the registration sensor 160 is switched from a turn-on state to a turn-off state by making a rear end portion Pb of the sheet P pass through the registration sensor 160 is set as a trigger for detecting the remaining jam of the sheet P.

The CPU 301 determines a distance L between the registration sensor 160 provided upstream near the registration roller 161 and the fixing inlet sensor 171 provided upstream near the fixing device 170 in the conveying path 22. In addition, a conveying speed V of the sheet P conveyed through the conveying path 22 is considered.

The leading end portion Pa of the sheet P is detected by the fixing inlet sensor 171, and time t1 at which the fixing inlet sensor 171 is switched from a turn-on state to a turn-off state by making the rear end portion Pb of the sheet P pass through the fixing inlet sensor 171 is considered. Time T1 from the time t0 at which the rear end portion Pb of the sheet P passes through the registration sensor 160 to the time t1 at which the rear end portion Pb of the sheet P passes through the fixing inlet sensor 171 can be obtained by the following Equation 1 using the distance L and the conveying speed V.

T1=L/V [Equation 1]

At this time, the conveying efficiency of the sheet P may be lowered due to the wear of the registration roller 161 or the configuration of the conveying apparatus itself. Assuming that a conveying margin time in consideration of the decrease in the conveying efficiency is m1, the time required for the rear end portion Pb of the sheet P to pass through the registration sensor 160 and then pass through the fixing inlet sensor 171 is {T1+m1} can be predicted.

The CPU 301 causes a timer 23 to count the elapsed time from the time t0 shown in FIG. 3A when the rear end portion Pb of the sheet P passes through the registration sensor 160. When the passage of the rear end portion Pb of the sheet P cannot be detected by the fixing inlet sensor 171 despite the fact that the elapsed time reaches time t2 after the elapse of {T1+m1} time, the CPU 301 determines that the remaining jam of the sheet P occurs.

### <Detection of Delayed Jam>

Next, the detection of the delayed jam of the sheet P at the position of the fixing inlet sensor 171 shown in FIG. 1 will be described with reference to FIG. 3B. As shown in FIG. 3B, the leading end portion Pa of the sheet P is detected by the registration sensor 160 provided upstream near the registration roller 161. As a result, the timing at which the registration sensor 160 is switched from a turn-off state to a turn-on state at time t10 is set as a trigger for detecting the delayed jam of the sheet P.

The CPU 301 sets the timing at which the passage of the leading end portion Pa of the sheet P is detected by the registration sensor 160 during the conveyance of the sheet P as the trigger for detecting the delayed jam of the sheet P. The CPU 301 determines the time t10 which is the timing of this trigger. In addition, the distance L between the registration sensor 160 and the fixing inlet sensor 171 on the conveying path 22 is considered. In addition, the conveying speed V of the sheet P conveyed through the conveying path 22 is considered.

Based on the time t10, the distance L, and the conveying speed V, the CPU 301 calculates time t11 at which the leading end portion Pa of the sheet P conveyed through the conveying path 22 between the registration sensor 160 and the fixing inlet sensor 171 reaches the fixing inlet sensor 171. As a result, time T2 required for the leading end portion Pa of the sheet P to pass through the registration sensor 160 and then the leading end portion Pa of the sheet P to pass through the fixing inlet sensor 171 can be calculated by {time t11−time t10}.

At this time, the conveying efficiency of the sheet P may be lowered due to the wear of the conveying roller or the like through which the sheet P is conveyed or the configuration of the conveying apparatus itself. The conveying margin time considering the decrease in the conveyance efficiency is set to be m2. Then, it can be predicted that the time required for the leading end portion Pa of the sheet P to pass through the registration sensor 160 and then reach the fixing inlet sensor 171 is {T2+m2}.

The CPU 301 activates a timer 23 shown in FIG. 2 by setting the timing of the time t10, at which the registration sensor 160 detects the passage of the leading end portion Pa of the sheet P, as the trigger for detecting the delayed jam of the sheet P. At elapsed time t12 after the elapse of {T2+m2} time, when the arrival of the leading end portion Pa of the sheet P cannot be detected by the fixing inlet sensor 171, the CPU 301 determines that the delayed jam of the sheet P occurs. It is to be noted that the detection method and the determination method of the delayed jam or the remaining jam of the sheet P of the present embodiment described above are merely examples, and other jam detection and determination methods may be used.

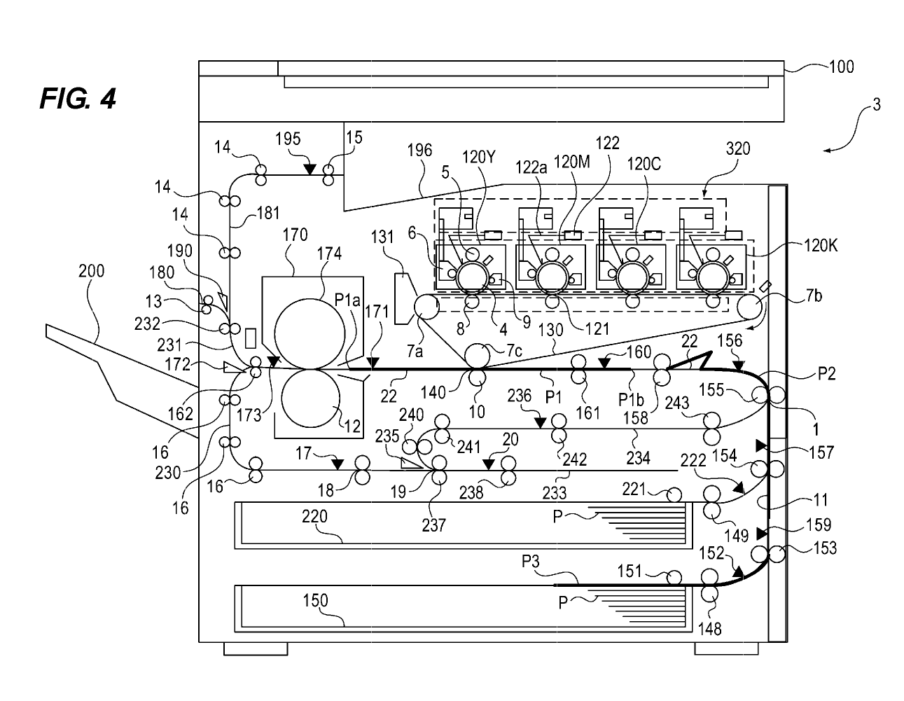

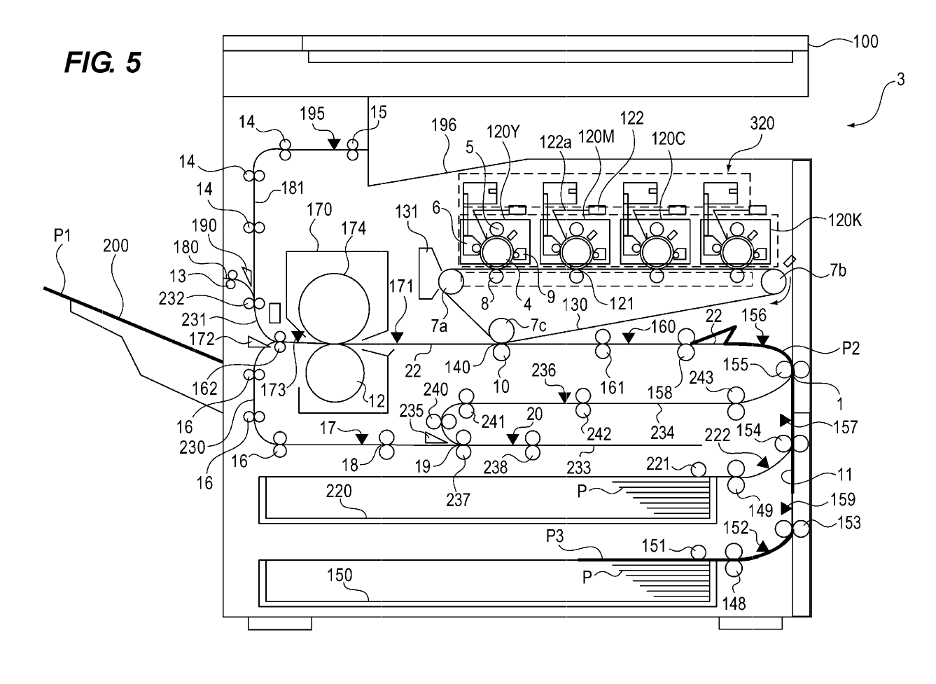

In the case of detecting the delayed jam or the remaining jam as described above, a case is considered in which a sheet P2 shown in FIG. 4 is the cause of the jam. In this case, the CPU 301 controls to stop the feeding of the sheet P2 which is the cause of the jam, and a sheet P3 which is already fed from the sheet cassette 150 existing upstream in the conveying direction of the sheet P2 as the sheets P2 and P3 remaining on the feeding path due to the occurrence of the jam. With respect to the sheet P1 existing downstream in the conveying direction below the sheet P2 which is the cause of the jam, the CPU 301 controls to continue the conveyance as usual, and discharges the sheet P1 onto the discharge tray 200 provided outside a machine as shown in FIG. 5.

The processing of all the sheets P in the image forming apparatus 3 ends. Here, the processing of the sheet P is processing of normally discharging the sheet P1 outside the machine and processing of stopping the feeding of the sheets P2 and P3 remaining on the feeding path due to the occurrence of the jam. At this time, the CPU 301 controls to display a message prompting jam clearance operation on a display portion 24a provided on the operation panel 24 to prompt the user to the jam clearance operation.

### <Conveying Control of Sheet>

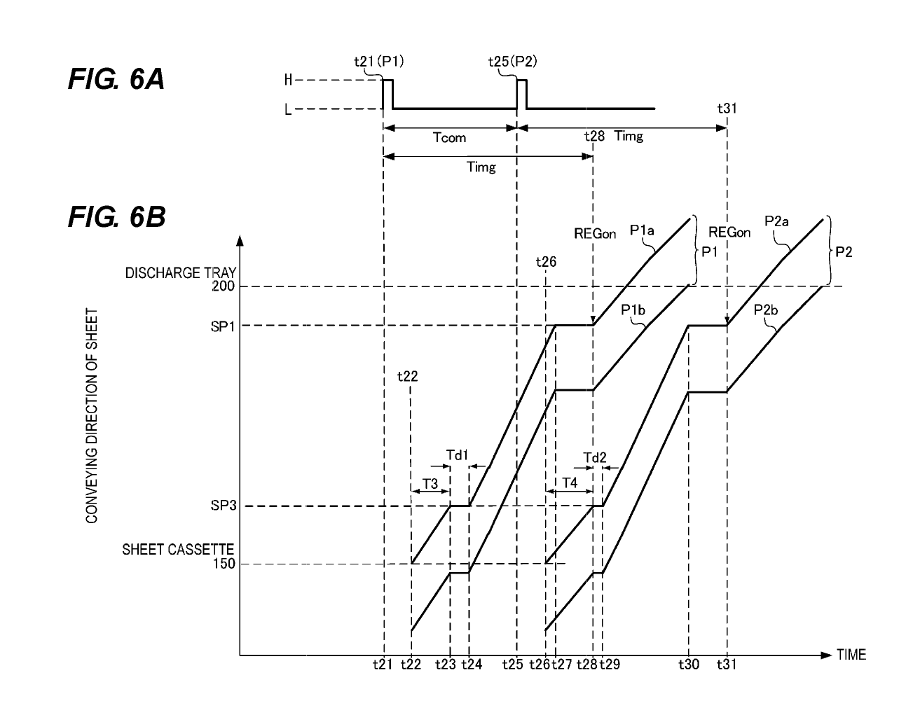

Next, the conveying control of the sheet P will be described with reference to FIGS. 6A and 6B. FIG. 6A is a diagram showing generation timing of an image forming start signal in a normal state. FIG. 6B is a transition diagram showing the transition from the leading end to the rear end of the sheet P. The CPU 301 controls the rotation start timing of the registration roller 161 so that the leading end portion Pa of the sheet P and the leading end of the toner image on the intermediate transfer belt 130 coincide with each other at the secondary transfer portion 140.

It is assumed that as the generation timing of the image forming start signal shown in FIG. 6A and the transition diagram shown in FIG. 6B go to the right on the horizontal axis, the time has elapsed. In addition, the transition diagram shown in FIG. 6B shows that the sheet P is progressed in the conveying direction as it goes up on the vertical axis. FIGS. 6A and 6B show an example in the case in which two sheets P in the sheet cassette 150 provided in the lower stage in FIG. 1 are fed.

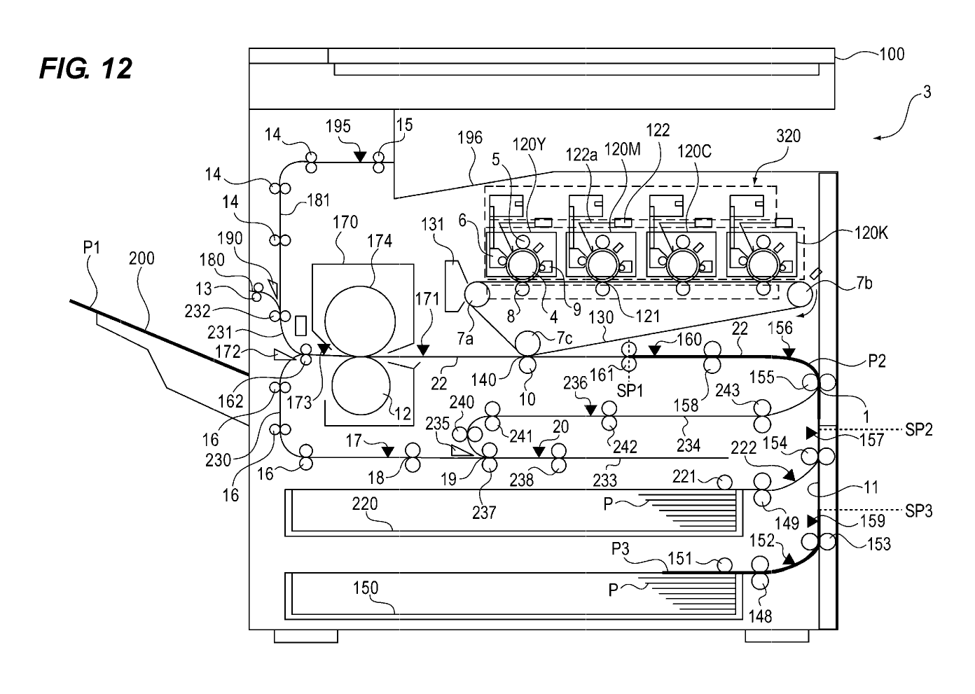

In the conveying control of the sheet P, stop positions SP1 to SP3 shown in FIG. 12 are set as the positions at which the sheet P is stopped.

The stop position SP1 shown in FIG. 12 is the nip portion of the registration roller 161, and is a position where the leading end portion Pa of the sheet P is stopped. The stop position SP2 shown in FIG. 12 is a position where the sheet P is stopped as the vertical path sensor 157 detects the leading end portion Pa of the sheet P, and is a position downstream near the vertical path sensor 157. The stop position SP3 shown in FIG. 12 is a position where the sheet P is stopped as the vertical path sensor 159 detects the leading end portion Pa of the sheet P, and is a position downstream near the vertical path sensor 159.

The stop position SP1 is provided to adjust the timing so that the leading end portion Pa of the sheet P and the leading end of the toner image on the outer peripheral surface of the intermediate transfer belt 130 coincide with each other at the secondary transfer portion 140. The stop position SP2 is provided to adjust the variation in the conveyance of the sheet P when the sheet P is fed from the upper sheet cassette 220. The stop position SP3 is provided to adjust the variation in the conveyance of the sheet P when the sheet P is fed from the lower sheet cassette 150.

As shown in FIG. 6A, at time t21, the CPU 301 generates the image forming start signal corresponding to the sheet P1. As shown in FIG. 6B, at time t22, the feeding of the sheet P1 starts from the lower sheet cassette 150 shown in FIG. 12. Then, when a leading end portion P1a of the sheet P1 is detected by the vertical path sensor 159 in order to adjust the variation in the feeding, the CPU 301 performs the stop of the sheet P1 by a stop time Td1 at the stop position SP3 based on the detection result of the vertical path sensor 159. Time t23 is the time when the leading end portion P1a of the sheet P1 reaches the stop position SP3.

After the elapse of the stop time Td1, at time t24, the CPU 301 controls to feed again the sheet P1 to perform the conveyance up to the stop position SP1 where the leading end portion P1a of the sheet P1 abuts on the nip portion of the stopped registration roller 161. At this time, after the leading end portion P1a of the sheet P1 is detected by the registration sensor 160, the CPU 301 controls to stop the leading end portion P1a of the sheet P1 at the stop position SP1 at a predetermined timing. At time t27, the leading end portion P1a of the sheet P1 reaches the stop position SP1.

On the other hand, at the time t21 shown in FIG. 6A, the image forming operation in the process unit 120 starts at the timing at which the image forming start signal corresponding to the sheet P1 changes from “low” to “high”. The image forming start signal at the time t21 is the start timing of the image forming operation on the sheet P1.

As shown in FIG. 6A, the CPU 301 controls the driving of the registration motor 510 and the conveying motor 509 at the timing of time t28 at which a predetermined time Timg has elapsed from the time t21. As a result, the conveying rollers 155 and 158 and the registration roller 161 start to rotate. As a result, the conveyance of the sheet P1 stopped at the stop position SP1 is restarted.

The timing at the time t28 at which the predetermined time Timg has elapsed from the generation timing of the image forming start signal at the time t21 is timing of a registration operation start (hereinafter, referred to as “REGon”). As a result, the leading end portion P1a of the sheet P1 and the leading end of the toner image on the outer peripheral surface of the intermediate transfer belt 130 are controlled so as to coincide with each other at the secondary transfer portion 140.

In addition, with respect to the generation timing of the image forming start signal for the sheet P1 at the time t21, the generation timing of the image forming start signal for the sheet P2 at time t25 is timing of the time t25 at which a predetermined time Tcom has elapsed from the time t21 based on the productivity of the image forming apparatus 3. For example, when the productivity of the image forming apparatus 3 is 80 pages per minute (ppm; the number of outputs per minute), the predetermined time Tcom is 750 msec.

In addition, the feeding start timings of the sheets P1 and P2 at the times t22 and t26 are later than the generation times (image forming operation start timings) t21 and t25 of the image forming start signals corresponding to each of the sheets P1 and P2. Such an image forming operation is referred to as “image forming preceding pattern”.

As a merit of the image forming preceding pattern, productivity can be increased. On the other hand, if a delay occurs in the conveyance of the sheet P, the jam margin for the sheet P is less than an interval between the rear end portion Pb of the preceding sheet P and the leading end portion Pa of a succeeding sheet P immediately thereafter. Therefore, there is a disadvantage that the jam tends to occur due to the delay of the sheet P.

As shown in FIG. 6B, time T3 from the time t22 at which the sheet P1 accommodated in the sheet cassette 150 starts to be fed to the time t23 at which the leading end portion P1a of the sheet P1 is detected by the vertical path sensor 159 and reaches the stop position SP3 is required. Similarly, time T4 (>T3) from time t26 at which the sheet P2 accommodated in the sheet cassette 150 starts to be fed to the time t28 at which a leading end portion P2a of the sheet P2 is detected by the vertical path sensor 159 and reaches the stop position SP3 is required. Therefore, at the time of feeding the sheet P2, a feeding delay of {T4−T3} time occurs with respect to the feeding of the sheet P1. The time t27 on the horizontal axis in FIG. 6B is a time at which the leading end portion P1a of the sheet P1 reaches the stop position SP1.

In the sheet P1, the stop time Td1 was taken at the stop position SP3. In the sheet P2, the stop time Td2 (<Td1) is set to be short at the stop position SP3 in order to recover the feeding delay of {T4−T3} time. This makes it possible to absorb the feeding delay of {T4−T3} time. As a result, at time t31, the leading end portion P2a of the sheet P2 can be stably conveyed to the stop position SP1 with respect to REGon timing of the sheet P2. Time t30 is a time at which the leading end portion P2a of the sheet P2 reaches the stop position SP1. Time t29 on the horizontal axis in FIG. 6B is a time to start feeding the sheet P2 stopped at the stop position SP3.

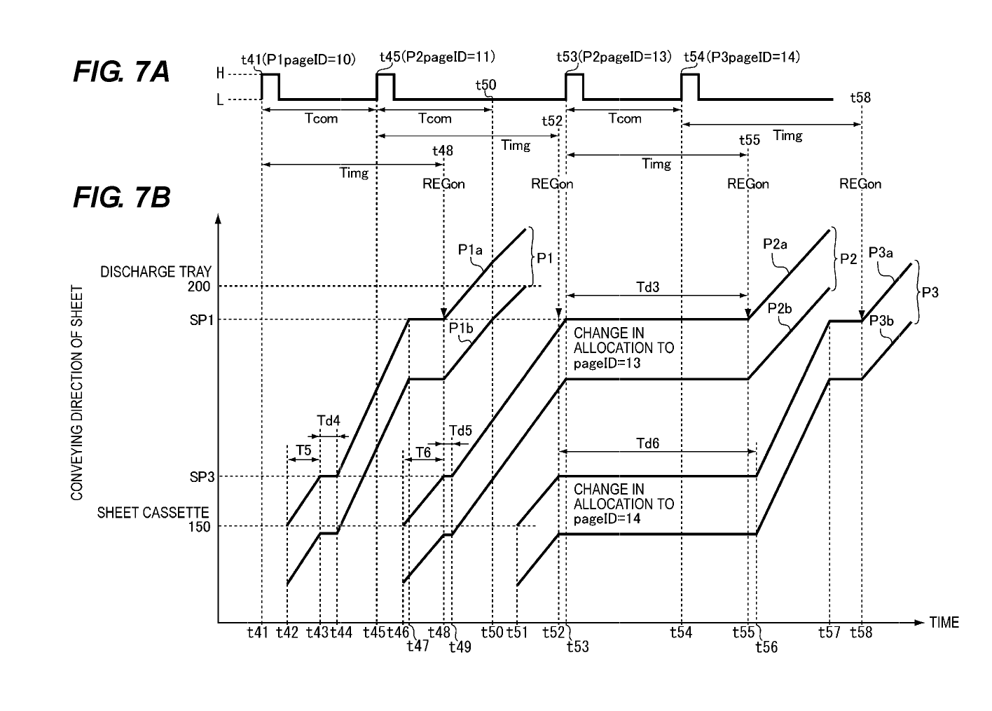

Next, the conveying delay of the sheet P after the variation in the feeding operation of the sheet P at the time of feeding the sheet P accommodated in the sheet cassette 150 is adjusted at the stop position SP1 or the stop position SP2 shown in FIG. 12 will be described with reference to FIGS. 7A and 7B. FIG. 7A is a diagram showing regeneration timing of the image forming start signal in a case in which it does not meet registration operation start timing. FIG. 7B is a transition diagram showing the transition from the leading end to the rear end of the sheet P.

The image forming start signal shown in FIG. 7A is changed from low to high at time t41. In addition, the image forming start signal is changed from low to high at time t45 at which the predetermined time Tcom has elapsed from time t41. The image forming adjustment is performed at time t50 at which the predetermined time Tcom has elapsed from the time t45. Therefore, FIGS. 7A and 7B show the appearance in which the image formation start timing at which the image forming start signal is changed from low to high is time t53 and delayed.

In FIG. 7B, the sheet P1 performs the REGon as usual at time t48 at which the predetermined time Timg has elapsed after the image forming start signal was generated at the time t41. As shown in FIG. 7B, time T5 from time t42 when the sheet P1 accommodated in the sheet cassette 150 starts to be fed to time t43 when the leading end portion P1a of the sheet P1 reaches the stop position SP3 is required. Time t44 on the horizontal axis in FIG. 7B is a time to start feeding the sheet P1 stopped at the stop position SP3.

Similarly, time T6 (>T5) from time t46 when the feeding of the sheet P2 accommodated in the sheet cassette 150 starts to the time t48 when the leading end portion P2a of the sheet P2 reaches the stop position SP3 is required. Therefore, at the time of feeding the sheet P2, a feeding delay of {T6−T5} time occurs with respect to the feeding of the sheet P1. The time t48 on the horizontal axis in FIG. 7B is a time to start the feeding of the sheet P1 stopped at the stop position SP1. Time t49 is a time to start feeding the sheet P2 stopped at the stop position SP3.

The sheet P1 was stopped at the stop position SP3 for a stop time Td4. In the sheet P2, stop time Td5 is set to be shorter than the stop time Td4 at the stop position SP3 in order to recover the feeding delay of {T6−T5} time. In the sheet P2, the variation at the time of the feeding is corrected to stop time Td5 Td4) at the stop position SP3, but furthermore, the conveying delay to the stop position SP1 occurs.

At this time, when the sheet P2 is conveyed without the occurrence of the jam, a case is considered in which the leading end portion P2a of the sheet P2 does not reach the stop position SP1 with respect to the REGon timing of the sheet P2 at time t52. In this case, the CPU 301 determines that the sheet P2 does not meet the image formation timing. At this time, the CPU 301 determines, based on the detection result of the registration sensor 160, whether the leading end portion P2a of the sheet P2 reaches the stop position SP1.

When it is determined that the sheet P2 does not meet the image formation timing, the CPU 301 controls to stop the sheet P2 at the stop position SP1 in the same manner as the conveying control in a normal state without forcibly stopping the sheet P2 as a jam. In addition, the CPU 301 controls to start feeding the succeeding sheet P3 immediately after the sheet P2. Therefore, as shown in FIG. 12, the CPU 301 stops the sheet P2 at the stop position SP1 and stops the sheet P3 at the stop position SP3.

As shown in FIG. 12, with respect to the sheet P2 stopped at the stop position SP1, the CPU 301 again generates, at the time t53, the image forming start signal generated at the time t45 in FIG. 7A. Then, by controlling the driving of the image forming portion 320 shown in FIG. 2, at the time t53, the image forming operation corresponding to the generated image forming start signal starts again.

That is, the CPU 301 determines that the timing at which the sheet P2 detected by the pickup sensor 152 (as detection portion) reaches the secondary transfer portion 140 does not meet the transfer timing at the secondary transfer portion 140. At that time, the delayed sheet P2 is temporarily stopped on the conveying path 22 between the merging portion 1 and the secondary transfer portion 140 shown in FIG. 12. In addition, the image forming portion 320 again forms an image corresponding to the delayed sheet P2.

Then, the temporarily stopped sheet P2 is conveyed to the secondary transfer portion 140. The image formed again is transferred onto the delayed sheet P2. In the present embodiment, the frequency of making the delayed sheet P a non-reusable sheet (hereinafter, referred to as “invalid sheet”) is decreased, so that the decrease in productivity is suppressed.

As shown in FIG. 7B, at the stop position SP1 shown in FIG. 12, the sheet P2 is stopped during a stop time Td3. At the REGon timing corresponding to the start of the image forming operation at time t55, the CPU 301 starts the rotation driving of the registration motor 510 and the conveying motor 509. As a result, the conveyance of the sheet P2 is restarted by the registration roller 161 and the conveying rollers 158 and 155.

In addition, in synchronization with the sheet P2, the sheet P3 is stopped at the stop position SP3 shown in FIG. 12 during a stop time Td6. The CPU 301 controls to start the rotation driving of the feeding motor 506 and the drawing motor 508. As a result, the conveyance of the sheet P3 is also restarted by the pickup roller 151, the feeding roller 148, and the conveying rollers 153 and 154.

In addition, as shown in FIG. 7A, time t54 at which the predetermined time Tcom preset based on the productivity of the image forming apparatus 3 has elapsed from the time t53 at which the image forming start signal corresponding to the sheet P2 is generated is the generation timing of the image forming start signal for the sheet P3. In addition, time t58 at which the predetermined time Timg has passed from the time t54 becomes the REGon timing for the sheet P3.

### <Sheet Conveying Control Upon Duplex Printing>

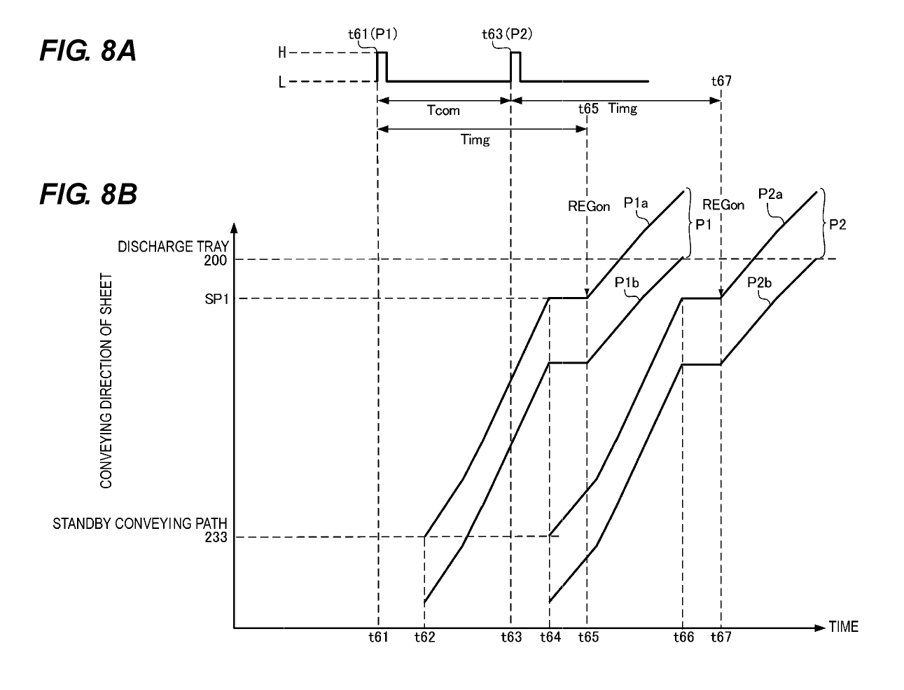

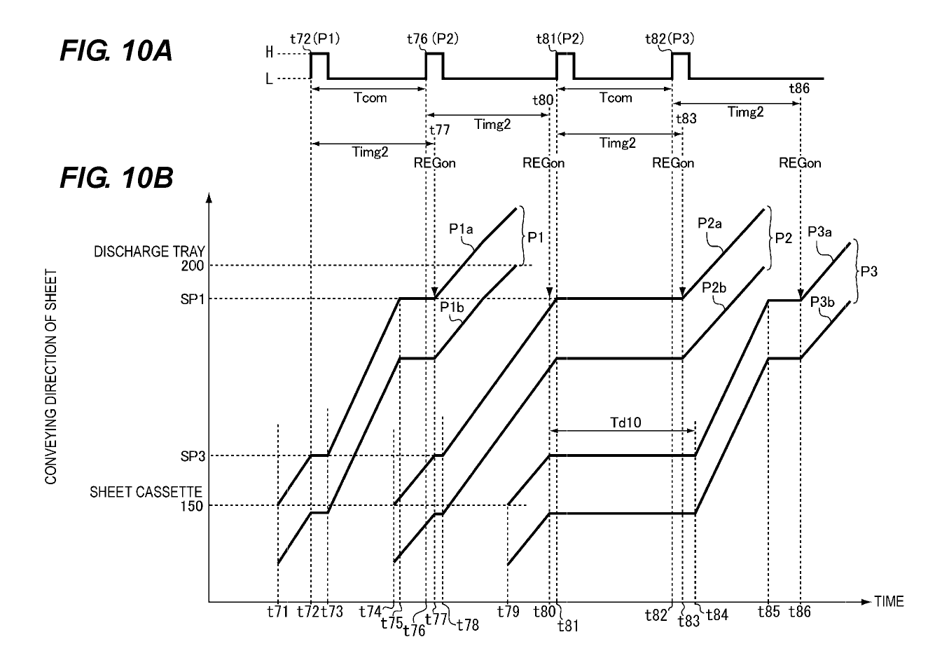

Next, the generation timing of the image forming start signal upon the duplex printing and the transition from the leading end to the rear end of the sheet P will be described with reference to FIGS. 8A and 8B. FIG. 8A is a diagram showing the generation timing of the image forming start signal upon the duplex printing. FIG. 8B is a transition diagram showing the transition from the leading end to the rear end of the sheet P. In FIGS. 6A and 6B and 7A and 7B described above and FIGS. 10A and 10B described below, the case in which the sheet P is fed from the sheet cassette 150 will be described. In FIGS. 8A and 8B, an operation after an image is formed on the first surface of the sheet P will be described. That is, the case in which the leading and back surfaces of the sheet P are reversed through the duplex conveying path 230, the standby conveying path 233, and the duplex feeding path 234, the sheet P is merged with the conveying path 22 at the merging portion 1 and is re-fed to form the image on the second surface of the sheet P is described. Similarly even upon the duplex printing shown in FIGS. 8A and 8B, the delay determination is performed at the stop position SP1 shown in FIG. 12.

The sheet P1 guided to the duplex conveying path 230 by the flapper 172 waits on the standby conveying path 233. Then, the sheet P1 is guided by the flapper 235 and conveyed to the duplex feeding path 234. Then, the sheet P2 following the sheet P1 is guided to the duplex conveying path 230 by the flapper 172, conveyed to the standby conveying path 233, and waits.

The image forming start signal of the second surface of the sheet P2 is generated at time t63 at which the predetermined time Tcom has elapsed after the image forming start signal of the second surface of the sheet P1 is generated at time t61 shown in FIG. 8A. Time t62 on the horizontal axis in FIG. 8B is a time to start feeding the sheet P1 from the standby conveying path 233. Time t64 is a time at which the leading end portion P1a of the second surface of the sheet P1 reaches the stop position SP1. The time t64 is a time to start feeding the sheet P2 from the standby conveying path 233.

At time t65 at which the predetermined time Timg has elapsed from the time t61 shown in FIG. 8A, the registration operation (REGon) of the sheet P1 starts at the stop position SP1. Time t66 is a time at which the leading end portion P2a of the second surface of the sheet P2 reaches the stop position SP1. The registration operation of the sheet P2 at the stop position SP1 starts at time t67 at which the predetermined time Timg has elapsed from the time t63 at which the image forming start signal of the second surface of the sheet P2 is generated.

### <Page Management>

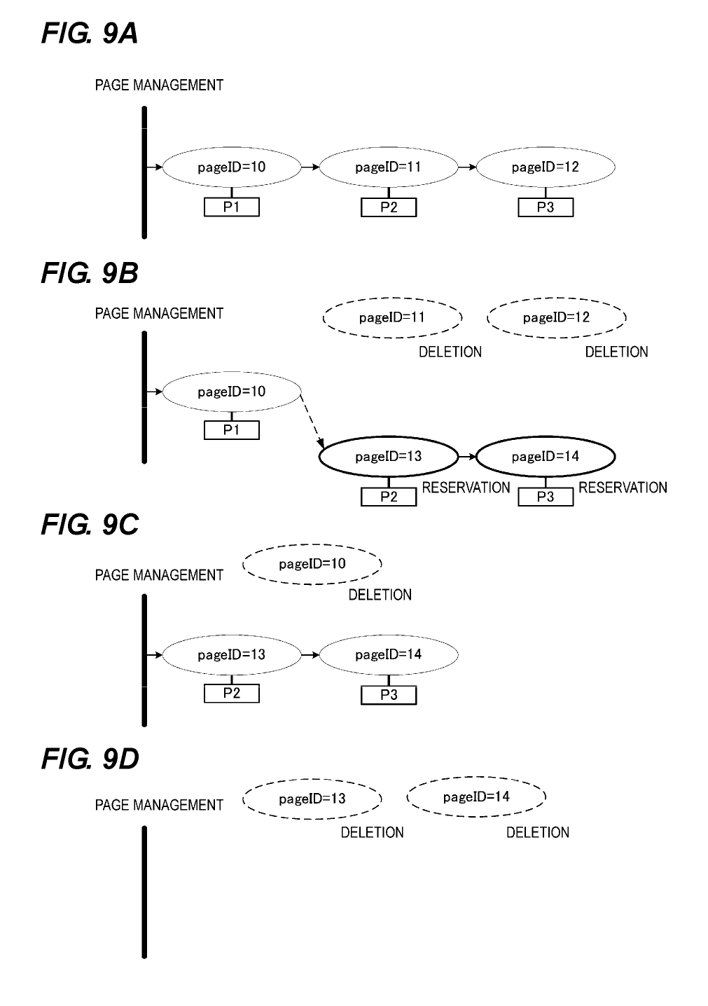

Next, an example of performing page management on each sheet P using a page unit data as a page identification (ID) will be described with reference to FIGS. 9A to 9D. FIGS. 9A to 9D are diagrams showing an example of performing page management on each sheet using a page unit data as a page ID.

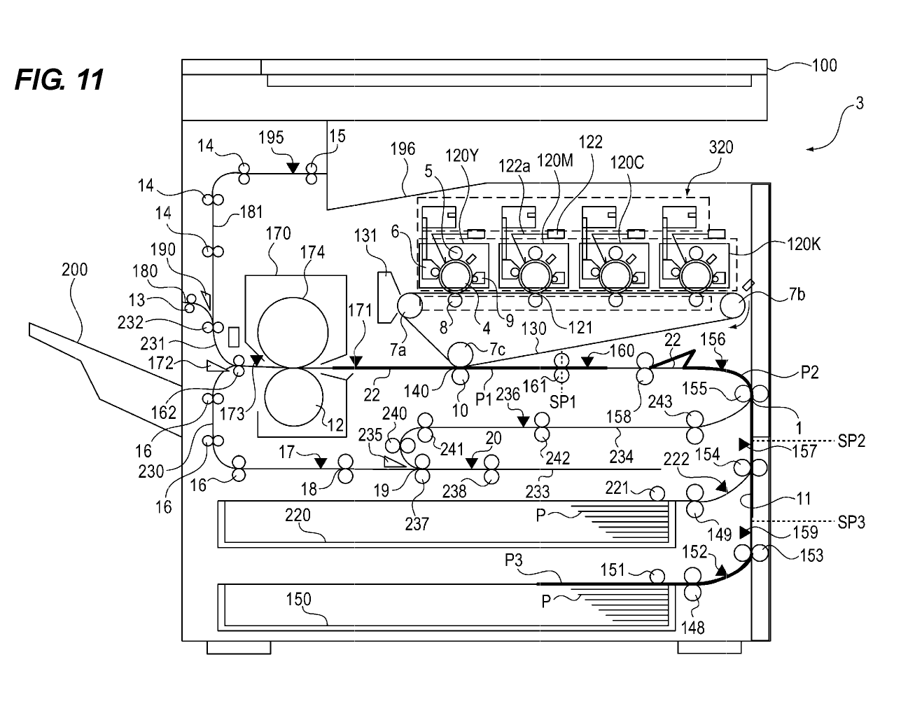

As shown in FIGS. 9A to 9D, the page management is performed on each of the sheets P1 to P3 using the page unit data as a unique ID which is a page ID. At the time of the start of the print job shown in FIG. 9A, “10”, “11”, and “12” as the page IDs are respectively allocated to the sheets P1, P2, and P3 shown in FIGS. 7A and 7B and 11.

A case is considered in which the sheet P2 to which “11” is allocated as the page ID at the time of the start of the print job shown in FIG. 9A does not reach the stop position SP1 upon the REGon. In this case, as shown in FIG. 9B, “11” and “12” which are the page IDs respectively allocated to the sheets P2 and P3 are deleted from the page management.

“13” and “14” are generated as new page IDs, and respectively allocated to the sheets P2 and P3. When the image formation can be continued, the new page ID is connected after “10” of the page ID allocated to the sheet P1. Here, as the case in which the image formation cannot be continued, a case in which the print job is canceled (stopped), a case in which there is no developer (toner) in the developing device 6, a case in which the cleaners 9 and 131 are fully filled with a recovered toner, and the like are considered.

Here, the CPU 301 determines whether the print job is canceled (stopped). The CPU 301 receives a signal in which the print job sent from the external device 28 such as a personal computer is canceled via the user interface (UI) 330. Alternatively, when the user cancels the print job through the operation panel 2 provided in the image forming apparatus 3, the CPU 301 receives the signal in which the print job is canceled via the user interface (UI) 330. As a result, the CPU 301 determines that the print job is canceled.

The CPU 301 determines that the timing at which the sheet P detected by each of the plurality of pickup sensors 152 and 222 (as detection portions) reaches the secondary transfer portion 140 does not meet the transfer timing of the secondary transfer portion 140. It is determined by the CPU 301 that the print job is canceled. In this case, the CPU 301 as the controller controls the image forming apparatus 3 to discharge the delayed sheet P onto the discharge trays 196 and 200 provided outside the machine of the image forming apparatus 3 without forming an image on the delayed sheet P.

In addition, the CPU 301 determines whether the image formation may be continued by the image forming portion 320. The image forming portion 320 has the developing device 6 serving as the developing portion that supplies a developer to the electrostatic latent image formed on the surface of the photosensitive drum 4 serving as the image bearing member. In addition, the image forming portion has the cleaner 9 which is the recovery device that recovers the residual developer remaining on the surface of the photosensitive drum 4 after the developer image formed on the surface of the photosensitive drum 4 is transferred onto the outer peripheral surface of the intermediate transfer belt 130. In addition, the image forming portion has the cleaner 131 which is the recovery device that recovers the residual developer remaining on the intermediate transfer belt 130 after the developer image transferred to the intermediate transfer belt 130 is transferred onto the sheet P.

The developing device 6 is provided with a toner sensor 25 for detecting whether there is the developer in the developing device 6. In addition, the cleaners 9 and 131 are provided with waste toner sensors 26 and 27, respectively, for detecting whether the cleaners 9 and 131 are fully filled with the developer. The CPU 301 determines whether out of the developer in the developing device 6 occurs based on the detection result of the toner sensor 25. Based on the detection results of the waste toner sensors 26 and 27, respectively, the CPU 301 determines whether the cleaners 9 and 131 are fully filled with the developer.

When there is no developer in the developing device 6 or when the cleaners 9 and 131 (in the recovery device) are fully filled with the developer, the CPU 301 determines that image formation by the image forming portion 320 cannot be continued.

The CPU 301 determines that the timing at which the sheet P detected by each of the plurality of pickup sensors 152 and 222 (detection portions) reaches the secondary transfer portion 140 does not meet the transfer timing of the secondary transfer portion 140. In addition, the CPU 301 determines that the image formation by the image forming portion 320 cannot be continued. In this case, the CPU 301 controls the image forming apparatus 3 to discharge the delayed sheet P onto the discharge trays 196 and 200 provided outside the machine of the image forming apparatus 3 without forming an image on the delayed sheet P.

For the image forming operation, the sheets P detected by the plurality of pickup sensors 152 and 222 (detection portions), respectively, may not meet the secondary transfer portion 140 at the transfer timing in the secondary transfer portion 140 that performs the image transfer to the sheet P. In this case, in the above-mentioned U.S. Patent Application Publication No. 2008/0025737 A1, the delayed sheet P was made an invalid sheet. For example, there is a case in which paper dust or the like adheres to the surface of the conveying roller and thus a conveying loss occurs instantaneously. In such a case, the sheet P may not meet the secondary transfer portion 140 at the transfer timing in the secondary transfer portion 140 that performs the image transfer to the sheet P. In U.S. Patent Application Publication No. 2008/0025737 A1, the sheet P which does not meet the image formation was made an invalid sheet.

By making the sheet the invalid sheet, there is a case in which the sheet P is discharged as a useless sheet P or a user is requested to forcibly remove a sheet as the jam of the sheet P at the worst. Such a case leads to deterioration in usability. In particular, when various inferior sheets are used, although there is a mechanism for improving separation failure at the feeding portion, stability against the conveying loss on the conveying path is lack.

In the present embodiment, under various conditions described above, the delayed sheet P is discharged onto the discharge trays 196 and 200 provided outside the machine of the image forming apparatus 3 without forming the image on the delayed sheet P. As a result, it is possible to reduce the frequency of the jam clearance operation by the user, and it is also possible to reuse the delayed sheet P discharged outside the machine of the image forming apparatus 3 without forming the image.

As the conveying operation of the sheet P, as shown in FIG. 12, the sheet P1 is discharged onto the discharge tray 200, the sheet P2 is stopped at the stop position SP1, and the sheet P3 is stopped at the stop position SP3. In this state, as shown in FIG. 9C, “10” of the page ID that is allocated to the sheet P1 discharged onto the discharge tray 200 is deleted.

As shown in FIG. 7A, next to the image forming start signal of “11” of the page ID generated at the time t45, the image forming start signal of the sheet P2 to which “13” of a new reserved page ID is allocated is generated at the time t53. Similarly, next to the image forming start signal of sheet P2 to which the “13” of the new reserved page ID generated at the time t53 is allocated, an image forming start signal of the sheet P3 to which “14” of a new reserved page ID is allocated is generated at the time t54.

In addition, in FIGS. 7A and 7B, the image formation adjustment is performed at the time t50. For this reason, the generation of the image forming start signal of the sheet P2 to which the “13” of the new reserved page ID generated at the time t53 is allocated is performed at timing at which the next image forming operation can be made after the image adjustment ends at the time t50. Time t51 on the horizontal axis in FIG. 7B is a time to start feeding the sheet P3 accommodated in the sheet cassette 150.

Finally, when each of the sheets P2 and P3 is discharged onto the discharge tray 200, as shown in FIG. 9D, the “13” and “14” of the new reservation page IDs respectively allocated to the sheets P2 and P3 are deleted. At this time, there is no page data in the page management.

Next, generation timing of an image forming start signal upon printing only a black (K) color and the transition from the leading end to the rear end of the sheet P will be described with reference to FIGS. 10A and 10B. FIG. 10A is a diagram showing the generation timing of the image forming start signal upon printing only the black color. FIG. 10B is a transition diagram showing the transition from the leading end to the rear end of the sheet P.

At time t71 in FIG. 10A, the CPU 301 starts feeding the sheet P1 from the sheet cassette 150. Next, at time t72, the CPU 301 generates a black image forming start signal corresponding to the sheet P1. At this time, at the time t72, the leading end portion P1a of the sheet P1 reaches the stop position SP3. Then, at time t73, the CPU 301 starts feeding the sheet P1 that is stopped at the stop position SP3. Thereafter, at time t74, the CPU 301 starts feeding the sheet P2 from the sheet cassette 150. Next, at time t75, the CPU 301 causes the leading end portion P1a of the sheet P1 to reach the stop position SP1. Next, at time t76, the CPU 301 generates a black image forming start signal corresponding to the sheet P2. Then, at time t77, the CPU 301 controls to start the registration operation of the sheet P1.

Here, time Timg2 from time t72 to the time t77 is considered. In addition, at the time t41 in FIG. 7A, the CPU 301 generates the image forming start signal upon printing using four colors of yellow (Y), magenta (M), cyan (C), and black (K). In addition, at the time t48, the CPU 301 starts the registration operation. Here, the time Timg from the time t41 to the time t48 is considered.

The time Timg2 from the time t72 to the time t77 shown in FIG. 10A is set to be shorter than the time Timg from the time t41 to the time t48 shown in FIG. 7A. This is because in the image forming apparatus 3 shown in FIG. 1, in the rotation direction of the intermediate transfer belt 130 which is rotated clockwise in FIG. 1, the process unit 120K for forming a black image is arranged at an upstream position closest to the secondary transfer portion 140.

Due to this timing difference, as shown in FIGS. 10A and 10B, the timing of starting feeding the sheet Pb from the sheet cassette 150 at the time t71 becomes earlier than the timing of generating the image forming start signal upon only the black printing at the time t72.

Then, at time t78, the CPU 301 controls to start feeding the sheet P2 that is stopped at the stop position SP3. Then, at time t79, the CPU 301 controls to start feeding the sheet P3 from the sheet cassette 150. Then, at time t80, the CPU 301 controls to start the registration operation of the sheet P2.

Even when the feeding start timing of the sheet P1 is earlier, the leading end portion P2a of the sheet P2 may not reach the stop position SP1 shown in FIG. 12 at the REGon timing of the sheet P2 at the time t80. This is because the conveying loss may occur in the sheet P2 on the conveying path from the stop position SP3 to the stop position SP1 shown in FIG. 12.

At time t81 shown in FIGS. 10A and 10B, the CPU 301 again generates the image forming start signal corresponding to the delayed sheet P2. At this time, the leading end portion P2a of the sheet P2 reaches the stop position SP1. Next, at time t82, the CPU 301 generates the image forming start signal corresponding to the sheet P3. Then, at time t83, the CPU 301 controls to start the registration operation of the delayed sheet P2. Then, at time t84, the CPU 301 controls to start feeding the sheet P3 that is stopped at the stop position SP3. Then, at time t85, the leading end portion P3a of the sheet P3 reaches the stop position SP1. Then, at time t86, the CPU 301 controls to start the registration operation of the sheet P3.

FIG. 11 is a view for describing the conveying operations of each sheet Pin the case in which the leading end portion P2a of the sheet P2 does not meet the stop position SP1 at the REGon timing of the sheet P2 at the time t52 shown in FIG. 7B. In FIG. 11, the CPU 301 controls to normally convey the preceding sheet P1 immediately before the delayed sheet P2 as it is and discharges the sheet P1 onto the discharge tray 200 as shown in FIG. 12. On the other hand, the CPU 301 controls the conveying of the delayed sheet P2 so that the delayed sheet P2 is stopped at the stop position SP1 as shown in FIG. 12. In addition, the CPU 301 controls the conveying of a succeeding sheet P3 immediately after the delayed sheet P2 so that the sheet P3 is stopped at the stop position SP3 as shown in FIG. 12.

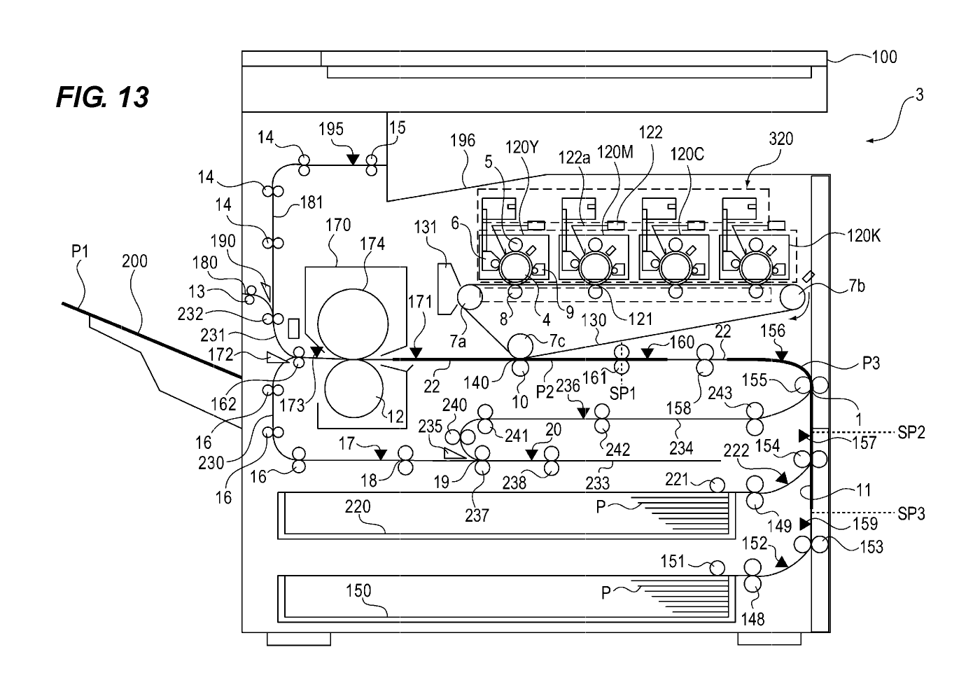

At time t55 shown in FIGS. 7A and 7B, after the REGon of the sheet P2, as shown in FIG. 13, the sheet P2 is conveyed toward the secondary transfer portion 140, and in the secondary transfer portion 140, the toner image on the outer peripheral surface of the intermediate transfer belt 130 is transferred. Time t56 on the horizontal axis in FIG. 7B is a time to start feeding the sheet P3 stopped at the stop position SP3.

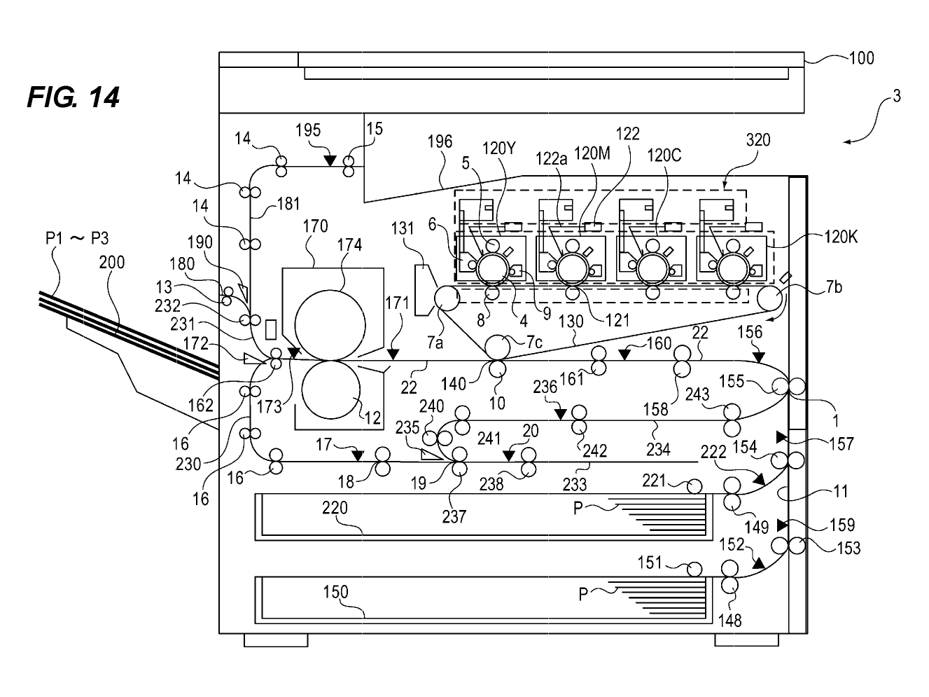

The sheet P3 is fed from the stop position SP3 and moves toward the stop position SP1. Time t57 on the horizontal axis in FIG. 7B is the time at which the sheet P3 stopped at the stop position SP3 is fed and the leading end portion P3a of the sheet P3 reaches the stop position SP1. The sheets P2 and P3 are continuously conveyed and then discharged onto the discharge tray 200 as shown in FIG. 14.

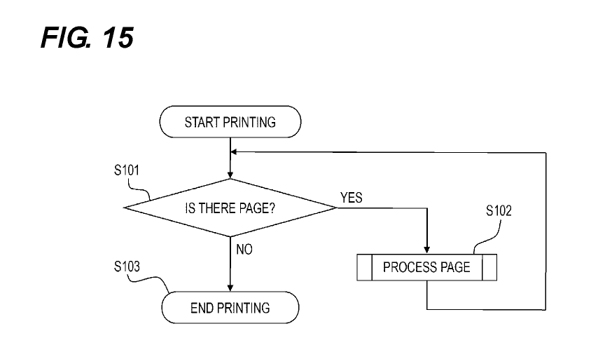

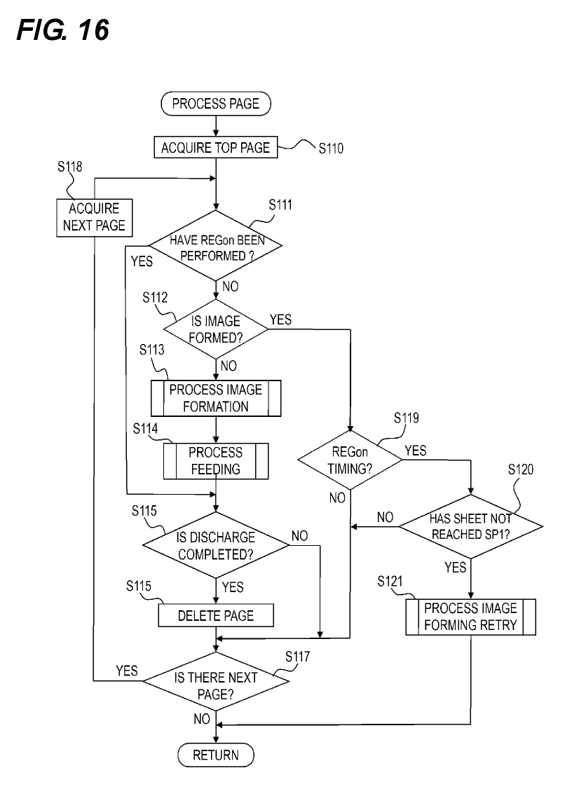

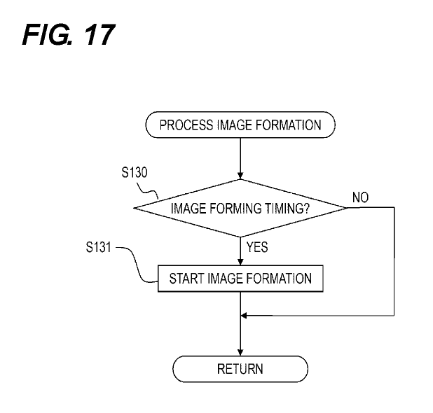

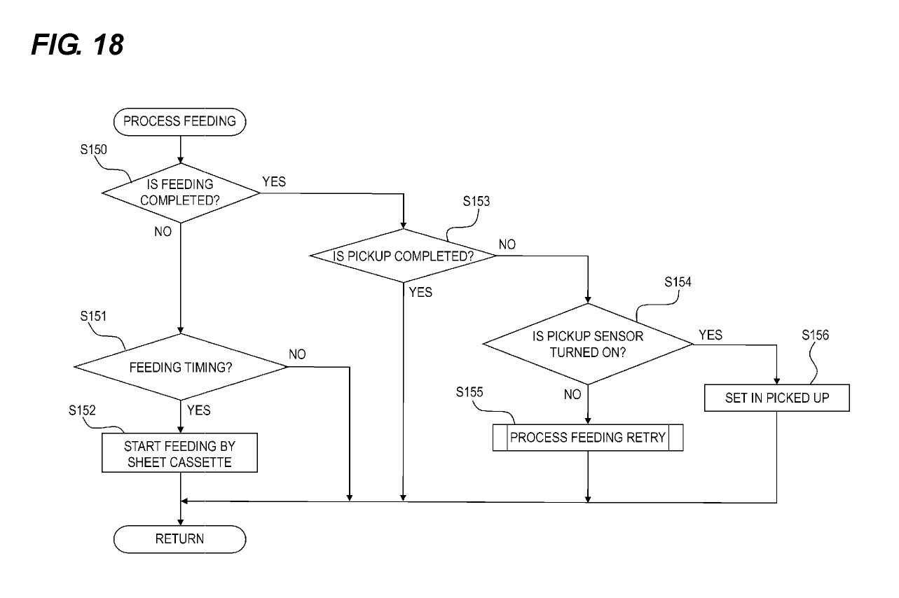

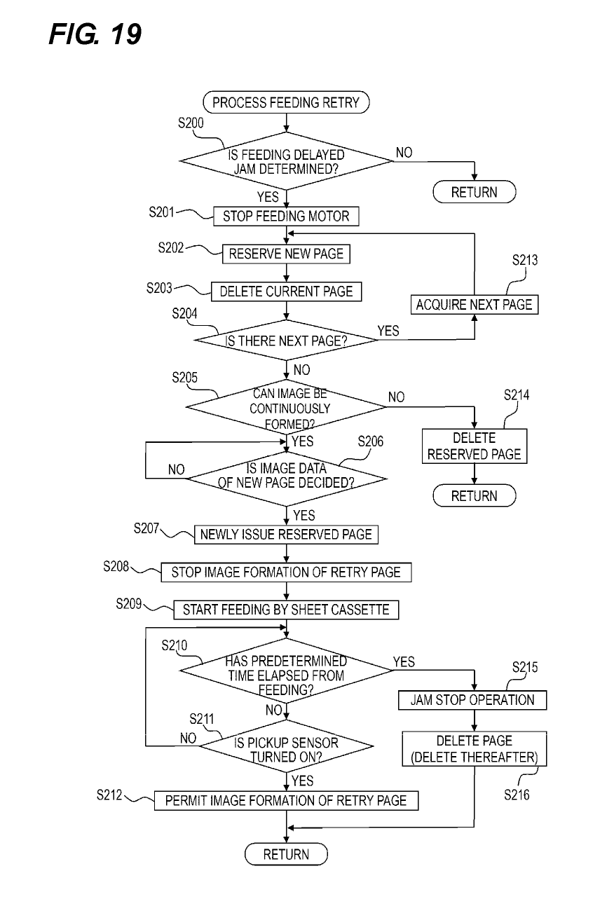

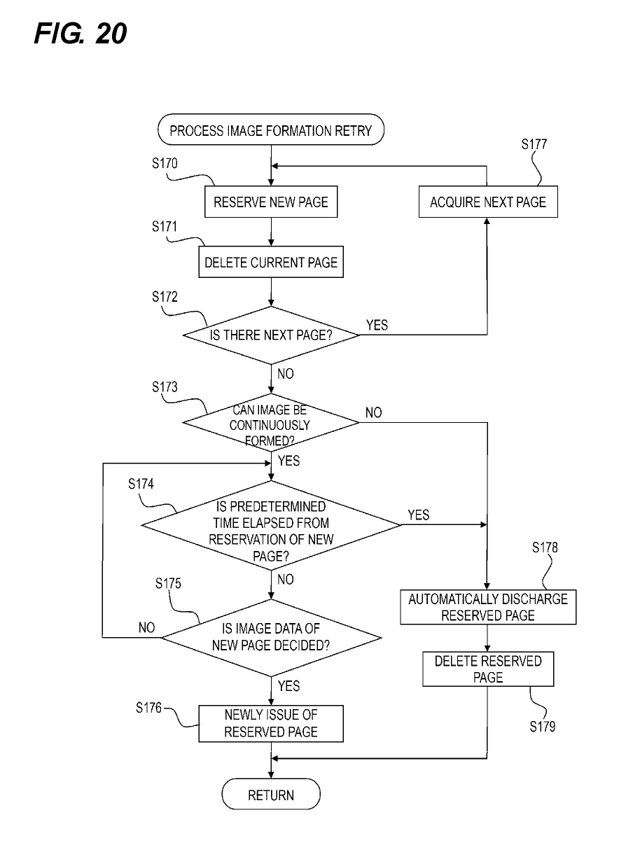

Next, the conveying operation of each sheet P in the case in which the leading end portion Pa of the sheet P does not meet the stop position SP1 at the REGon timing of the sheet P will be described with reference to FIGS. 15 to 20. FIG. 15 is a flowchart showing the determination as to whether there is a page. FIG. 16 is a flowchart showing a page processing operation. FIG. 17 is a flowchart showing the image forming processing. FIG. 18 is a flowchart showing the feeding processing of the sheet P. FIG. 19 is a flowchart showing feeding retry processing of the sheet P. FIG. 20 is a flowchart showing image forming retry processing.

<Determination as to Whether there is Page>

First, the page processing operation will be described with reference to FIG. 15. Upon receiving a print start instruction from the external device 28 or the operation panel 24 shown in FIG. 2 via the UI 330, the CPU 301 starts the page processing operation shown in FIG. 15. In step S101 of FIG. 15, the CPU 301 determines whether there is a page based on the print information transmitted from the UI 330. In the determination as to whether there is a page in step S101, the CPU 301 confirms whether the page ID exists in the print information transmitted from the UI 330, for the page management shown in FIG. 9A.

At the start of the print job shown in FIG. 9A, “10”, “11”, and “12” exist as page IDs. The CPU 301 recognizes that the “10”, “11”, “12” exist as the page IDs, and in step S101, determines that there is a page.

In the determination in step S101, if it is determined that there is a page, the process proceeds to step S102, and the CPU 301 performs the page processing shown in FIG. 16. After performing the page processing in step S102, the process returns to step S101. In addition, in the determination in step S101, if it is determined that there is no page, the process proceeds to step S103 to end the processing.

### <Page Processing>

Next, the page processing operation will be described with reference to FIG. 16. In step S110 of FIG. 16, the CPU 301 acquires data of a top page. As shown in FIG. 9A, in the processing in step S110, the page ID of the top page acquires “10” allocated to the sheet P1 which is the top page.

As shown in FIG. 9B, a case is considered in which the leading end portion P2a of the sheet P2 does not meet the stop position SP1 at the REGon timing of the succeeding sheet P2 immediately after the sheet P1 which is the top page. Even in this case, the CPU 301 causes “10” allocated to the sheet P1 to be acquired for the page ID of the top page.

On the other hand, when the leading end portion P2a of the sheet P2 does not meet the stop position SP1 at the REGon timing of the succeeding sheet P2 immediately after the sheet P1, a case is considered in which the sheet P1 is discharged onto each of the discharge trays 200 and 196. In this case, the top page is replaced with the sheet P2. In addition, in FIG. 9B, the page ID allocated to the sheet P2 is replaced with “13” from “11”. Even in this case of FIG. 9C, the CPU 301 causes “13” allocated to the sheet P2 to be acquired for the page ID of the top page.

Next, the process proceeds to step S111, and the CPU 301 determines whether REGon of the sheet P to which the page ID acquired in step S110 is allocated has been performed. In the determination in step S111, if it is determined that REGon of the sheet P to which the page ID acquired in step S110 is allocated has not been performed, the process proceeds to step S112.

In step S112, the CPU 301 determines whether the image is formed on the sheet P to which the page ID acquired in step S110 is allocated. In the determination in step S112, the CPU 301 confirms that the image forming start signal changes from low to high at the generation timing of the image forming start signal at the times t21 and t25 shown in FIG. 6A. As a result, it is determined that the image is formed on the sheet P to which the page ID acquired in step S110 is allocated.

In the determination in step S112, if it is determined that the image is not formed on the sheet P to which the page ID acquired in step S110 is allocated, the process proceeds to step S113. In step S113, the CPU 301 executes the image forming processing shown in FIG. 17. Then, the process proceeds to step S114. In step S114, the CPU 301 executes the feeding processing shown in FIG. 18. Then, the process proceeds to step S115. In step S115, the CPU 301 determines whether the sheet P to which the page ID acquired in step S110 is allocated is discharged onto each of the discharge trays 200 and 196.

The CPU 301 determines whether the sheet P to which the page ID acquired in step S110 is allocated is discharged onto each of the discharge trays 200 and 196 provided outside the machine from the image forming apparatus 3. At this time, the CPU 301 determines, based on the detection result of the fixing outlet sensor 173 or the discharge sensor 195, whether the sheet P to which the page ID acquired in step S110 is allocated is discharged onto each of the discharge trays 200 and 196.

In the determination in step S115, if it is determined that the sheet P to which the page ID acquired in step S110 is allocated is discharged onto each of the discharge trays 200 and 196, the process proceeds to step S116. In step S116, the CPU 301 deletes the page ID acquired in step S110 from the page management.

Then, the process proceeds to step S117, and the CPU 301 determines whether there is another page ID next to the page ID acquired in step S110. In the determination in step S117, it is determined that there is another page ID next to the page ID acquired in step S110. In this case, the process proceeds to step S118, and after the CPU 301 acquires another page ID, the process returns to step S111.

In the determination in step S117, when there is no another page ID next to the page ID acquired in step S110, the page processing shown in FIG. 16 ends. In the determination in step S115, if it is determined that the sheet P to which the page ID acquired in step S110 and S118 is allocated is not discharged onto each of the discharge trays 200 and 196, the process proceeds to step S117.

In the determination in step S111, if it is determined that REGon of the sheets P to which the page IDs acquired in steps S110 and S118 are allocated have been performed, the process proceeds to step S115. In the determination in step S112, if it is determined that the image is formed on the sheets P to which the page IDs acquired in steps S110 and S118 are allocated, the process proceeds to step S119.

In step S119, the CPU 301 determines whether the sheets P to which the page IDs acquired in steps S110 and S118 are allocated are at the REGon timing. In the determination in step S119, if it is determined that the sheets P to which the page IDs acquired in steps S110 and S118 are allocated are at the REGon timing, the process proceeds to step S120.

In step S120, the CPU 301 determines whether the leading end portions Pa of the sheets P to which the page IDs acquired in steps S110 and S118 are allocated reach the stop position SP1. For example, the CPU 301 determines whether the leading end portion P2a of the sheet P2 reaches the stop position SP1 at the REGon timing of the sheet P2 at the time t52 in FIGS. 7A and 7B.

At this time, the CPU 301 determines that the leading end portion P2a of the sheet P2 does not reach the stop position SP1 at the REGon timing of the sheet P2 at the time t52 in FIGS. 7A and 7B. The determination as to whether the leading end portion Pa of the sheet P reaches the stop position SP1 can be made based on the detection result of the registration sensor 160 shown in FIG. 12.

The CPU 301 determines whether the timing at which the sheet P detected by each of the plurality of pickup sensors 152 and 222 reaches the secondary transfer portion 140 meets the transfer timing of the secondary transfer portions 140. In the determination in step S120, the CPU 301 determines that the leading end portions Pa of the sheets P do not reach the stop position SP1 at the REGon timing of the sheets P to which the page IDs acquired in steps S110 and S118 are allocated. In this case, the process proceeds to step S121. In step S121, the CPU 301 executes the image forming retry processing shown in FIG. 20. Thereafter, the CPU 301 ends the page processing shown in FIG. 16.

In the determination in step S120, the CPU 301 determines that the leading end portions Pa of the sheets P reach the stop position SP1 at the REGon timing of the sheets P to which the page IDs acquired in steps S110 and S118 are allocated. In this case, the process proceeds to step S117. In the determination in step S119, if the CPU 301 determines that the sheets P to which the page IDs acquired in steps S110 and S118 are allocated are not at the REGon timing, the process proceeds to step S117.

### <Image Forming Processing>

Next, the image forming processing shown in step S113 of FIG. 16 will be described with reference to FIG. 17. In step S130 of FIG. 17, the CPU 301 determines whether the sheets P to which the page IDs acquired in steps S110 and S118 are allocated are at the image forming timing.

Here, the CPU 301 determines whether the sheets P to which the page IDs acquired in steps S110 and S118 are allocated are at the image forming timing. At that time, as shown in FIG. 7A, the CPU 301 confirms that the predetermined time Tcom elapses from the times t41, t45, and t53, respectively, at which the image forming start signal of the sheet P to which the preceding page ID is allocated changes from low to high. In addition, when the image forming adjustment or the pre-rotation are being performed, the CPU 301 confirms that the image adjustment or the pre-rotation ends. This is a condition for determining that these conditions are at the image formation timing.

In the determination in step S130, if the CPU 301 determines that the sheets P to which the page IDs acquired in steps S110 and S118 are allocated are at the image forming timing, the process proceeds to step S131 and the CPU 301 controls to start the image forming operation.

As shown in FIGS. 6A and 7A, at the timing when the image forming start signal changes from low to high, the image forming operation starts by each process unit 120. Thereafter, the CPU 301 ends the image forming processing shown in FIG. 17.

In the determination in step S130, the CPU 301 determines that the sheets P to which the page IDs acquired in steps S110 and S118 are allocated are not at the image forming timing. In this case, the CPU 301 ends the image forming processing shown in FIG. 17.

### <Feeding Processing>

Next, the feeding processing shown in step S114 of FIG. 16 will be described with reference to FIG. 18. In step S150 of FIG. 18, the CPU 301 determines whether the sheets P to which the page IDs acquired in steps S110 and S118 are allocated are already fed from each of the sheet cassettes 150 and 220 shown in FIG. 1.

The determination as to whether the sheets P to which the page IDs allocated in steps S110 and S118 are allocated are already fed from each of the sheet cassettes 150 and 220 shown in FIG. 1 is based on whether the rotation driving of the feeding motors 506 and 505 shown in FIG. 2 starts. The feeding operation of the sheets P from each of the sheet cassettes 150 and 220 shown in FIG. 1 is performed at timing at which the rear end portion P1b of the preceding sheet P1 and the leading end portion P2a of the succeeding sheet P2 immediately thereafter do not contact each other as shown at times t22 and t26 in FIG. 6B.

In the determination in step S150, if the CPU 301 determines that the sheets P to which the page IDs acquired in steps S110 and S118 are allocated are not fed from each of the sheet cassettes 150 and 220 shown in FIG. 1, the process proceeds to step S151. In step S151, the CPU 301 determines whether the sheets P to which the page IDs acquired in steps S110 and S118 are allocated are at the feeding start timing from each of the sheet cassettes 150 and 220 shown in FIG. 1.

Here, the feeding start timing from each of the sheet cassettes 150 and 220 is appropriately set based on the sheet size of the sheet P, the feeding from the sheet cassette 220 in the upper part in FIG. 1, or the feeding from the sheet cassette 150 in the lower part in FIG. 1. The feeding operation is performed at timing at which the rear end portion P1b of the preceding sheet P1 and the leading end portion P2a of the succeeding sheet P2 immediately thereafter do not contact each other as shown at times t22 and t26 in FIG. 6B.

In the determination in step S151, the CPU 301 determines that the sheets P to which the page IDs acquired in steps S110 and S118 are allocated are at the feeding start timing from each of the sheet cassettes 150 and 220 shown in FIG. 1. In this case, the process proceeds to step S152.

In step S152, the CPU 301 controls the driving of each of the feeding motors 506 and 505 to rotate each of the pickup rollers 151 and 221 and each of the feeding rollers 148 and 149, and to start the feeding of the sheets P from each of the sheet cassettes 150 and 220. Thereafter, the CPU 301 ends the feeding processing shown in FIG. 18.

In the determination in step S151, the CPU 301 determines that the sheets P to which the page IDs acquired in steps S110 and S118 are allocated are not at the feeding start timing from each of the sheet cassettes 150 and 220 shown in FIG. 1. In this case, the CPU 301 ends the feeding processing shown in FIG. 18.

In the determination in step S150, the CPU 301 determines that the sheets P to which the page IDs acquired in steps S110 and S118 are allocated are already fed from each of the sheet cassettes 150 and 220 shown in FIG. 1. In this case, the process proceeds to step S153. In step S153, the sheets P to which the page IDs acquired in steps S110 and S118 are allocated are fed out from each of the sheet cassettes 150 and 220 shown in FIG. 1 by the pickup rollers 151 and 221. In addition, the sheets P are separately fed one by one by each of the feeding rollers 148 and 149. At this time, the CPU 301 determines whether the sheet P is picked up.

Here, it is possible to determine whether the sheets P are picked up from each of the sheet cassettes 150 and 220 based on the detection results of each of the pickup sensors 152 and 222 shown in FIG. 1. In the determination in step S153, the CPU 301 determines that the sheets P to which the page IDs acquired in steps S110 and S118 are allocated are picked up from each of the sheet cassettes 150 and 220 shown in FIG. 1. In this case, the CPU 301 ends the feeding processing shown in FIG. 18.

In the determination in step S153, if the CPU 301 determines that the sheets P to which the page IDs acquired in steps S110 and S118 are allocated are not picked up from each of the sheet cassettes 150 and 220 shown in FIG. 1, the process proceeds to step S154. In step S154, the CPU 301 determines whether the pickup sensors 152 and 222 shown in FIG. 1 are turned on. Here, the sheet P separately fed from the sheet cassette 150 is detected by the pickup sensor 152, and the sheet P separately fed from the sheet cassette 220 is detected by the pickup sensor 222.

In the determination in step S154, if the CPU 301 determines that each of the pickup sensors 152 and 222 is not turned on, the process proceeds to step S155. In step S155, the CPU 301 executes the feeding retry processing shown in FIG. 19. Thereafter, the CPU 301 ends the feeding processing shown in FIG. 18.

In the determination in step S154, if the CPU 301 determines that each of the pickup sensors 152 and 222 is turned on, the process proceeds to step S156. In the determination in step S156, the CPU 301 sets such that the sheets P to which the page IDs acquired in steps S110 and S118 are allocated are picked up from each of the sheet cassettes 150 and 220 shown in FIG. 1. Thereafter, the CPU 301 ends the feeding processing shown in FIG. 18.

### <Feeding Retry Processing>

Next, the feeding retry processing will be described with reference to FIG. 19. FIG. 19 is a flowchart showing the feeding retry processing. In step S200 of FIG. 19, the CPU 301 determines whether the delayed jam determination is made. The sheets P to which the page IDs acquired in steps S110 and S118 of FIG. 16 are allocated are at the feeding start timing from each of the sheet cassettes 150 and 220 shown in FIG. 1. Each of the pickup sensors 152 and 222 may not be turned on even after a preset time elapses from the feeding start timing. In this case, the CPU 301 determines that the delayed jam occurs.

In the determination in step S200, if the CPU 301 determines that the delayed jam occurs, the process proceeds to step S201 to perform an operation of stopping the driving of each of the feeding motors 505 and 506. In the determination in step S200, if the CPU 301 determines that no delayed jam occurs, the CPU 301 ends the feeding retry process shown in FIG. 19.

After the stop operations of the feeding motors 505 and 506 in step S201, the process proceeds to step S202. In step S202, as shown in FIG. 9B, the CPU 301 reserves a new page ID for the page IDs acquired in steps S110 and S118 in FIG. 16.

Here, the reservation of the new page ID is described with reference to the image forming retry processing shown in FIG. 20. Then, the process proceeds to step S203, and the CPU 301 deletes a current page ID acquired as shown in FIG. 9B. Then, the process proceeds to step S204, and the CPU 301 determines whether there is a next page. In the determination in step S204, if the CPU 301 determines that there is a next page, the process proceeds to step S213, and the CPU 301 acquires the next page ID. Then, the CPU 301 returns the processing to step S202.

In the determination in step S204, if the CPU 301 determines that there is no next page, the process proceeds to step S205, and the CPU 301 determines whether the image formation can be continued. Here, as the case in which it is impossible to continue the image formation, the case in which the developer (toner) is not present in the developing device 6 shown in FIG. 1 or the case in which the toner recovered in the cleaners 9 and 131 is full is considered.

In the determination in step S205, if the CPU 301 determines that the image formation can be continued, the process proceeds to step S206, and the CPU 301 determines whether the image data of the new page is decided. Here, the decision of the image data is made based on whether the data for image formation can be prepared again in the image forming portion 320. This is because the data for the image formation is usually performed with the data developed by the image, but the image data once developed is erased by activating the image formation data on the top page. This is to ensure a limited memory space for the next image formation when the image is continuously formed. If it is desired to form the same image again, it needs to be developed from the compressed image data again.

However, in order to develop the image in an order different from the normal order of the image development, it is necessary to search for the image data to be developed again and perform the image development processing again. In addition, even in the image development processing, the development time varies depending on the compression ratio of the image data. In addition, when there is the image data during the development execution, it is necessary to stop the processing. Therefore, in step S206, it is determined whether the image data of the new page is decided.

In the determination in step S206, if the CPU 301 determines that the image data of the new page is decided, the process proceeds to step S207, and the CPU 301 performs a new issuance of the reserved page. Here, the new issuance of the reserved page is described with reference to the image forming retry processing shown in FIG. 20.

Then, the process proceeds to step S208, and the CPU 301 controls to stop the image formation for the newly issued page (hereinafter, referred to as “retry page”). Then, the process proceeds to step S209, and the CPU 301 controls to start the feeding operation of the sheet P from the same sheet cassette in which the sheet P determined to have the delayed jam is accommodated. Here, the feeding start operation of the sheet P is performed by allowing the CPU 301 to start driving the feeding motor 506 or 505 shown in FIG. 2.

Then, the process proceeds to step S210, and the CPU 301 determines whether the preset time has elapsed from the time at which the driving of the feeding motor 506 or 505 in step S209 starts. At this time, the elapsed time is measured by the timer 23 shown in FIG. 2. The CPU 301 controls to start driving the feeding motor 506 or 505. By doing so, the pickup roller 151 or 221 and the feeding roller 148 or 149 are rotated. Then, the CPU 301 controls to execute again the feeding of the sheet P from the same sheet cassette in which the sheet P determined to have the delayed jam is accommodated. At that time, the CPU 301 detects that the jam occurs when the feeding cannot be performed within the preset time.

In the determination of step S210, if the CPU 301 determines that the predetermined time has not elapsed from the time at which the driving of the feeding motor in step S209 starts, the process proceeds to step S211. In step S211, the CPU 301 determines whether each of the pickup sensors 152 and 222 shown in FIG. 1 is turned on.

When the sheet P is fed from the sheet cassette 150, the pickup sensor 152 detects the sheet P, and when the sheet P is fed from the sheet cassette 220, the pickup sensor 222 detects the sheet P. In the determination in step S211, if the CPU 301 determines that the pickup sensor 152 or 222 is turned on, the process proceeds to step S212, and the CPU 301 permits the image formation of the retry page stopped in step S208. Then, the CPU 301 ends the feeding retry processing shown in FIG. 19.

In the determination in step S211, if the CPU 301 determines that each of the pickup sensors 152 and 222 is turned off, the process returns to step S210. In the determination in step S210, if the CPU 301 determines that the predetermined time has elapsed from the time at which the driving of each of the feeding motor 506 and 505 in step S209 starts, the process proceeds to step S215, and the CPU 301 performs the jam stop operation. Here, in the jam stop operation, the CPU 301 controls to stop driving the feeding motor 506 or 505 shown in FIG. 2.

Then, the process proceeds to step S216, and the CPU 301 deletes all the page IDs newly issued in step S207. Then, the CPU 301 ends the feeding retry processing shown in FIG. 19. In the determination in step S205, if the CPU 301 determines that the image formation cannot be continued, the process proceeds to step S214, and the CPU 301 performs the deletion of the page reserved in step S202. Then, the CPU 301 ends the feeding retry processing shown in FIG. 19.

### <Image Forming Retry Processing>

Next, the image forming retry processing will be described with reference to FIG. 20. FIG. 20 is a flowchart showing the image forming retry processing. In step S170 of FIG. 20, the CPU 301 reserves the new page ID for the acquired page ID. Here, in the reservation of the new page ID, as shown in FIG. 9B, the page ID is not yet added.

Then, the process proceeds to step S171, and the CPU 301 deletes the current page ID acquired. Then, the process proceeds to step S172, and the CPU 301 determines whether there is a next page. In the determination in step S172, if the CPU 301 determines that there is a next page, the process proceeds to step S177, and the CPU 301 acquires the next page ID. Then, the process returns to step S170.

In the determination in step S172, if the CPU 301 determines that there is no next page, the process proceeds to step S173, and the CPU 301 determines whether the image formation can be continued. Here, as the case in which it is impossible to continue the image formation, the case in which the developer (toner) is not present in the developing device 6 shown in FIG. 1 or the case in which the toner recovered in the cleaners 9 and 131 is full is considered.

In the determination in step S172, if the CPU 301 determines that there is no next page, the process proceeds to step S173, and the CPU 301 determines whether the image formation can be continued. In the determination in step S173, if the CPU 301 determines that the image formation can be continued, the process proceeds to step S174, and the CPU 301 determines whether the predetermined time has elapsed after the reservation of the new page is performed.

Here, the predetermined time is assumed to be about one minute. If there is a waiting time exceeding one minute, there is a possibility that the trace of the conveying roller 158 remains on the sheet P due to the influence of the nip pressure of the conveying roller 158 shown in FIG. 1. In the determination in step S174, if the CPU 301 determines that the predetermined time has not elapsed after the reservation of the new page is performed, the process proceeds to step S175, and the CPU 301 determines whether the image data of the new page is decided.

In the determination in step S175, if the CPU 301 determines that the image data of the new page is decided, the process proceeds to step S176, and the CPU 301 performs a new issuance of the reserved page. Here, the new issuance of the reserved page means that the page ID “10” and the page ID “13” indicated by the dotted line in FIG. 9B are consecutive image forming pages.

Then, the CPU 301 ends the image forming retry processing shown in FIG. 20. In the determination in step S175, if the CPU 301 determines that the image data of the new page is not decided, the process returns to step S174. In the determination in step S174, if the CPU 301 determines that the predetermined time has elapsed after the reservation of the new page is performed, the process proceeds to step S178, and the CPU 301 performs the discharge processing on the sheet P corresponding to the reserved page.

Here, the CPU 301 determines whether the processing of forming the image corresponding to the delayed sheet P again by the image forming portion 320 is performed within a predetermined time. The CPU 301 determines whether the processing of forming the image corresponding to the delayed sheet P delayed by the image forming portion 320 again is performed within the predetermined time by measuring the elapsed time from the time when the reservation of the new page is performed by the timer 23 shown in FIG. 2.

The CPU 301 determines that the timing at which the sheet P reaches the secondary transfer portion 140 does not meet the transfer timing at the secondary transfer portion 140. In addition, the CPU 301 determines that the processing of forming the image corresponding to the delayed sheet P again by the image forming portion 320 has not been performed within the predetermined time.

In this case, the CPU 301 controls the image forming apparatus 3 to discharge the delayed sheet P onto the discharge trays 196 and 200 provided outside the machine of the image forming apparatus 3 without forming the image on the delayed sheet P. Then, the process proceeds to step S179, and the CPU 301 deletes the reserved page. Then, the CPU 301 ends the image forming retry processing shown in FIG. 20.

In the present embodiment, it is possible to shorten the time required for the re-fed sheet P to reach the secondary transfer portion 140. In addition, when the conveying loss of the sheet P in the feeding portion occurs, by automatically forming the image again, it is possible to suppress a decrease in productivity without stopping the image forming apparatus 3. In addition, by discharging the delayed sheet P onto the discharge trays 196 and 200 provided outside the machine of the image forming apparatus 3 without forming the image on the delayed sheet P, it is possible to reduce the trouble of the user's jam clearance operation and reuse the discharged sheet P.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-001820, filed Jan. 10, 2018, which is hereby incorporated by reference herein in its entirety.

What is claimed is:

1. An image forming apparatus which forms an image on a sheet based on a print job, comprising:
a sheet storing portion which stores a sheet;
a detection portion which detects a sheet fed from the sheet storing portion;
a conveying portion which conveys the sheet along a conveying path;
an image forming portion which forms an image;
a transfer portion which transfers the image formed by the image forming portion to the sheet; and
a controller which controls the conveying portion and the image forming portion to stop the sheet at a predetermined position of the conveying path upstream of the transfer portion, and convey the sheet to the transfer portion after causing the image forming portion to start to form the image on the sheet in a case where the sheet reaches the detection portion but it is determined that the sheet which has been detected by the detection portion does not reach the transfer portion by transfer timing of the transfer portion based on timing when the detection portion detects the sheet.

2. The image forming apparatus according to claim 1, wherein the conveying path includes a duplex conveying path through which the sheet is conveyed for forming an image on a second surface of a sheet in duplex printing, and
the detection portion also detects the sheet conveyed from the duplex conveying path.

3. The image forming apparatus according to claim 1, wherein in a case where the print job is canceled after the sheet is stopped at the predetermined position, the controller controls the conveying portion and the image forming portion to discharge the sheet stopped at the predetermined position without forming an image on the sheet.

4. The image forming apparatus according to claim 1, wherein in a case where the image formation is not started within a predetermined time on the sheet stopped at the predetermined position, the controller controls the conveying portion and the image forming portion to discharge the sheet stopped at the predetermined position without forming an image on the sheet.

5. The image forming apparatus according to claim 1, wherein in a case where the image forming portion does not perform the image formation on the sheet stopped at the predetermined position, the controller controls the conveying portion and the image forming portion to discharge the sheet stopped at the predetermined position without forming an image on the sheet.

6. The image forming apparatus according to claim 5, wherein the image forming portion includes:
a developing device which supplies a developer to a latent image formed on an image bearing member; and
a recovery device which recovers a residual developer remaining on the image bearing member after a developer image is transferred,
wherein the controller determines that the image formation by the image forming portion is not continuously made when pot of developer in the developing device occurs or when the recovery device is fully filled with the developer.
